(19) United States
(12) Patent Application Publication
(10) Pub. No.: US 2017/0147992 A1
(43) Pub. Date: May 25, 2017

(54) SYSTEMS AND METHODS FOR FIELD REPLACEMENT OF SERVICEABLE UNITS

(71) Applicant: Civiq Smartscapes, LLC, Milford, MA (US)

(72) Inventors: Kyle R. Bowers, Boxborough, MA (US); Benjamin P. Lee, Wayland, MA (US); Parag N. Shah, Carlisle, MA (US); Kenneth J. Gray, Uxbridge, MA (US); Benjamin M. Lawler, Beverly, MA (US); Alexander P. Stroshane, Medway, MA (US)

(21) Appl. No.: 15/423,081

(22) Filed: Feb. 2, 2017

Related U.S. Application Data
(63) Continuation of application No. 15/353,248, filed on Nov. 16, 2016.
(60) Provisional application No. 62/255,760, filed on Nov. 16, 2015.

(51) Int. Cl. G06Q 10/00; G06Q 10/06

(52) U.S. Cl. CPC G06Q 10/20; G06Q 10/06311

(57) ABSTRACT

Systems and methods for replacing modules of a personal communication structure are provided. The modules are configured to be field replaceable, such that field service personnel are able to quickly and easily replace modules in locations with high pedestrian traffic. Embodiments of the personal communication structure include a frame and one or more field replaceable units supported by the frame. The field replaceable units may include an RF bay field replaceable unit, a display field replaceable unit, a user interface field replaceable unit, an environmental sensor field replaceable unit, an electronics bay field replaceable unit, and/or a network bay field replaceable unit.

### CROSS-REFERENCE TO RELATED APPLICATIONS

This application claims priority to U.S. Provisional Patent Application No. 62/255,760, filed Nov. 16, 2015, the entire contents of which are incorporated by reference herein.

### FIELD OF INVENTION

The present disclosure relates generally to methods and apparatus for replacing components of a personal communication structure (PCS).

### BACKGROUND

In some public or semi-public areas, various structures can be used for communication or to obtain access to goods and services. For example, telephone booths can be used to place telephone calls. Interactive kiosks can be used to obtain access to information, products, and/or services. Some interactive kiosks are self-service kiosks, which allow patrons of a business to perform service tasks that were historically performed by business employees. For example, the automated teller machine (ATM) is a self-service kiosk that allows users to deposit funds into a financial account, withdraw funds from an account, check an account balance, etc.—tasks that were historically performed with the assistance of a human bank teller. As another example, some retail stores allow customers to scan and pay for their items at self-service checkout kiosks rather than checkout stations staffed by human cashiers.

An interactive kiosk generally includes a computer terminal, which executes software and/or controls hardware peripherals to perform the kiosk's tasks. Many interactive kiosks are deployed inside buildings that are accessible to the public (e.g., banks, stores), in areas where the building operators can monitor the kiosks and protect them from unauthorized access. In some cases, interactive kiosks are integrated into walls of buildings (e.g., some ATMs are integrated into walls of banks), fastened to walls, or placed against walls, which can protect the kiosks from unauthorized access and reduce the occurrence of potentially dangerous events such as the kiosks tipping.

### SUMMARY OF THE INVENTION

In recent years, public telephone booths have dwindled in number and many of the remaining booths have fallen into relative disuse and disrepair. The demise of the public telephone booth can be traced, in part, to the increasing prevalence of mobile phones and to the widespread use of communication networks for non-telephonic purposes. Many people who wish to participate in telephone conversations in public places prefer the convenience of their own mobile phones to the inconvenience of a stationary phone booth. Furthermore, in contrast to many mobile phones, conventional public telephone booths do not allow users to access Internet-based data and services. Many people who wish to access Internet-based data and services in public places use mobile computing devices (e.g., smartphones or laptop computers) and wireless networks (e.g., mobile broadband networks or Wi-Fi networks) to do so. In short, for many people, the public telephone booth is less convenient and less functional than other readily-available options for connecting to a communication network.

Despite the seeming ubiquity of mobile computing devices, many people are often left with insufficient access to telephonic or Internet-based services. In some areas, wireless network coverage may be poor or nonexistent. In areas where wireless networks are available, the number of network users or the volume of network traffic may exceed the capacity of the network, leaving some users unable to connect to the network, and degrading quality of service for users who are able to connect (e.g., degrading audio quality of phone calls or reducing rates of data communication). Even when wireless networks are available and not congested, some people may not have access to telephonic or Internet-based services because they may not have suitable computing devices or network-access agreements (e.g., a person may not own a computing device, may own a computing device but not have a network-access agreement with an Internet-service provider, may not own a mobile computing device, may have a mobile computing device with an uncharged battery, etc.).

There is a need for personal communication structures (PCSs) that enhance public access to communication networks. Such PCSs may enhance access to communication networks by expanding network coverage (e.g., making communication networks available in areas where they would otherwise be unavailable), expanding network capacity (e.g., increasing the capacity of communication networks in areas where such networks are available), expanding access to end-user computing devices and telephones, and/or expanding access to charging outlets for mobile computing devices. By enhancing access to communication networks, the PCSs may improve the employment prospects, educational opportunities, and/or quality of life for individuals, families, and communities that would otherwise have limited access to communication networks.

In various examples, the PCSs described herein include units that are easy to remove and replace in the field. These field replaceable units (FRUs) typically include only few mechanical and/or electrical connections for ease of installation and removal. A service person can remove a faulty FRU and install a new FRU in a matter of seconds or minutes. This results in less downtime for the PCS and reduces costs and risks associated with PCS repair work in public locations. The faulty FRU can be brought to a service center for repair, cleaning, and/or disposal.

In one aspect, the subject matter described herein relates to a personal communication structure that includes: a frame; a field replaceable unit; and a mechanism for moving the field replaceable unit from an installed position disposed on the frame to a service position disposed outside the frame. The mechanism includes: at least one bearing for sliding the field replaceable unit in a horizontal direction from the installed position to a second position outside the frame; and at least one hinge for tilting the field replaceable unit from the second position to the service position.

In certain examples, the field replaceable unit includes a Wi-Fi component, a small cell component, and/or an antenna component. The installed position can be proximate a top of the frame (e.g., on top of the frame). The at least one bearing can be disposed in or on a bracket attached to the field replaceable unit. In some examples, the mechanism further includes: a tray supporting at least one component of the field replaceable unit; a first pair of brackets attached to the tray; and a second pair of brackets attached to the frame and engaged with the first pair of brackets, wherein the first pair of brackets are configured to slide along the second pair of brackets, using the at least one bearing. The first pair of brackets and the second pair of brackets may be considered to form at least part of a rail system, as described herein.

In another aspect, the subject matter described herein relates to a method of servicing a personal communication structure. The method includes: sliding a field replaceable unit from an installed position on a frame of the personal communication structure to a second position outside the frame, wherein the sliding is achieved using at least one bracket attached to the field replaceable unit and slidably engaged with at least one bracket attached to the frame; tilting the field replaceable unit relative to the personal communication structure from the second position to a service position using at least one hinge; removing at least one component from the field replaceable unit; installing a corresponding at least one component into the field replaceable unit; tilting the field replaceable unit from the service position to the second position; and sliding the field replaceable unit from the second position to the installed position.

In some examples, the at least one component includes a Wi-Fi component, a small cell component, and/or an antenna component. The installed position can be proximate a top of the frame (e.g., on top of the frame). The at least one bracket attached to the field replaceable unit and/or the at least one bracket attached to the frame can include or use a bearing. The corresponding at least one component can include a replacement for the at least one component. Installing the corresponding at least one component can include replacing the field replaceable unit with a new field replaceable unit.

In another aspect, the subject matter described herein relates to a personal communication structure that includes: a frame; a field replaceable unit; and a mechanism for moving the field replaceable unit from an installed position disposed on the frame to a service position outside the frame. The mechanism includes: a tray supporting at least one component of the field replaceable unit, the tray including a first end and a second end; a pair of hanging members including a first hanging member attached to the first end and a second hanging member attached to the second end; a pair of lifting brackets including a first lifting bracket pivotably connected to the first hanging member and a second lifting bracket pivotably connected to the second hanging member, wherein the first lifting bracket is pivotably connected to a corresponding first end of the frame using a first pin, and wherein the second lifting bracket is pivotably connected to a corresponding second end of the frame using a second pin; and at least one actuator for rotating the pair of lifting brackets about the first and second pins.

In various examples, the field replaceable unit includes a Wi-Fi component, a small cell component, and/or an antenna component. The installed position can be proximate a top of the frame (e.g., on top of the frame). The lifting brackets can be L-shaped. In some embodiments, the mechanism is configured to maintain the tray in a level orientation during movement from the installed position to the service position.

In another aspect, the subject matter described herein relates to a method of servicing a personal communication structure. The method includes: rotating a pair of lifting brackets pivotably connected to a frame of the personal communication structure, wherein rotation of the pair of lifting brackets causes a field replaceable unit to move from an installed position disposed on the frame to a service position outside the frame; removing at least one component from the field replaceable unit; installing a corresponding at least one component into the field replaceable unit; and rotating the pair of lifting brackets to move the field replaceable unit from the service position to the installed position.

In some examples, the at least one component includes a Wi-Fi component, a small cell component, and/or an antenna component. The installed position can be proximate a top of the frame (e.g., on top of the frame). At least one component of the field replaceable unit can be disposed on a tray connected to the pair of lifting brackets, and the tray can remain in a level orientation during movement from the installed position to the service position. The tray can be attached to a pair of hanging members, and the hanging members can be pivotably connected to the pair of lifting brackets. Installing the corresponding at least one component into the field replaceable unit can include replacing the field replaceable unit with a new field replaceable unit.

In another aspect, the subject matter described herein relates to a personal communication structure that includes: a frame; and at least one field replaceable unit disposed on the frame. The at least one field replaceable unit can be an RF bay field replaceable unit, a display field replaceable unit, a user interface field replaceable unit, an environmental sensor field replaceable unit, an electronics bay field replaceable unit, and/or a network bay field replaceable unit.

In certain examples, the at least one field replaceable unit is disposed in a compartment defined by the frame. The personal communication structure is preferably configured to be field serviceable down to the frame. The at least one field replaceable unit can be configured to be serviced by a person standing on ground supporting or next to the frame. In some embodiments, the at least one field replaceable unit includes the RF bay field replaceable unit, and the RF bay field replaceable unit includes a Wi-Fi access point, a small cell, and/or at least one antenna. The RF bay field replaceable unit can be disposed proximate a top of the personal communication structure.

In various examples, the personal communication structure includes a mechanism for moving the at least one field replaceable unit from an installed position disposed on the frame to a service position outside the frame. The mechanism can include: at least one bearing for sliding the at least one field replaceable unit in a horizontal direction from the installed position to a second position outside the frame; and at least one hinge for tilting the at least one field replaceable unit from the second position to the service position. Alternatively or additionally, the mechanism can include: a tray supporting the at least one field replaceable unit, the tray including a first end and a second end; a pair of hanging members including a first hanging member attached to the first end and a second hanging member attached to the second end; a pair of lifting brackets including a first lifting bracket pivotably connected to the first hanging member and a second lifting bracket pivotably connected to the second hanging member, wherein the first lifting bracket is pivotably connected to a corresponding first end of the frame using a first pin, and wherein the second lifting bracket is pivotably connected to a corresponding second end of the frame using a second pin; and at least one actuator for rotating the pair of lifting brackets about the first and second pins.

In another aspect, the subject matter described herein relates to a method of servicing a personal communication structure. The method includes: running a self-test to detect a fault associated with a field replaceable unit disposed on the personal communication structure; transmitting information about the fault from the personal communication structure to a remote entity; deploying field service personnel with a new field replaceable unit to a location where the personal communication structure is installed; permitting the field service personnel to gain access to a compartment containing the field replaceable unit; replacing the field replaceable unit with the new field replaceable unit; and running a self-test to confirm good working order of the new field replaceable unit.

In some instances, permitting the field service personnel to gain access includes sending a request and receiving a grant to unlock the compartment. In one example, replacing the field replaceable unit includes: sliding the field replaceable unit from an installed position on a frame of the personal communication structure to a second position outside the frame, wherein the sliding is achieved using at least one bracket attached to the field replaceable unit and slidably engaged to at least one bracket attached to the frame; tilting the field replaceable unit relative to the personal communication structure from the second position to a service position using at least one hinge; installing the new field replaceable unit; tilting the new field replaceable unit from the service position to the second position; and sliding the new field replaceable unit from the second position to the installed position.

In certain embodiments, replacing the field replaceable unit includes: rotating a pair of lifting brackets pivotably connected to a frame of the personal communication structure, wherein rotation of the pair of lifting brackets causes the field replaceable unit to move from an installed position disposed on the frame to a service position outside the frame; installing the new field replaceable unit; and rotating the pair of lifting brackets to move the new field replaceable unit from the service position to the installed position.

Elements of embodiments or examples described with respect to a given aspect of the subject matter described herein can be used in various embodiments or examples of another aspect of the invention. For example, it is contemplated that features of dependent claims depending from one independent claim can be used in apparatus, systems, and/or methods of any of the other independent claims.

Other aspects and advantages of the invention will become apparent from the following drawings, detailed description, and claims, all of which illustrate the principles of the invention, by way of example only.

### BRIEF DESCRIPTION OF THE DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1 is a block diagram of a personal communication structure (PCS), in accordance with some embodiments.

FIG. 2 is a schematic of a power distribution subsystem of a PCS, in accordance with some embodiments.

FIG. 3 is a schematic of a network subsystem of a PCS, in accordance with some embodiments.

FIG. 4 is a schematic of a maintenance subsystem of a PCS, in accordance with some embodiments.

FIG. 5 is a block diagram of a user interface subsystem of a PCS, in accordance with some embodiments.

FIG. 6 is a schematic of a user interface subsystem of a PCS, in accordance with some embodiments.

FIG. 7 is a schematic of a display module of a PCS, in accordance with some embodiments.

FIG. 8 illustrates an arrangement of compartments of a PCS, in accordance with some embodiments.

FIGS. 9A, 9B, and 9C show respective front perspective, side, and exploded front perspective views of a PCS, in accordance with some embodiments.

FIGS. 10A, 10B, and 10C show respective side perspective, front perspective, and exploded front perspective views of a frame of a PCS, in accordance with some embodiments.

FIG. 11 shows a perspective view of a portion of a PCS, in accordance with some embodiments.

FIGS. 12A and 12B show front perspective views of a PCS with ribbed panels, in accordance with some embodiments.

FIG. 12C shows a schematic side view of a ribbed panel, in accordance with some embodiments.

FIG. 13 is an exemplary schematic block diagram of a field replaceable unit (FRU) system in a PCS, in accordance with some embodiments.

FIG. 14 is a schematic, perspective view of hoist bolts in a PCS, in accordance with some embodiments.

FIG. 15 is a schematic, perspective view of an RF bay FRU in a PCS, in accordance with some embodiments.

FIG. 16A is an exploded, schematic, perspective view of a Display FRU assembly in a PCS, in accordance with some embodiments.

FIG. 16B is a schematic, perspective view of a Display FRU in a service position in a PCS, in accordance with some embodiments.

FIG. 17A is a schematic, front perspective view of a User Interface FRU removed from a PCS, in accordance with some embodiments.

FIG. 17B is a schematic, rear perspective view of a User Interface FRU removed from a PCS, in accordance with some embodiments.

FIGS. 18A and 18B are schematic, perspective views of an electronics Bay FRU and a Network Bay FRU in a single, back-to-back enclosure and removed from a PCS, in accordance with some embodiments.

FIG. 19 is a flowchart of an example method of servicing an FRU in a PCS, in accordance with some embodiments.

FIGS. 20A, 20B, 20C, and 20D are schematic, perspective views of a mechanism for moving an RF bay FRU from an installed position on the frame to a service position in front of the frame, in accordance with some embodiments.

FIGS. 21A and 21B are schematic, perspective views of a mechanism for moving an RF bay FRU from an installed position on the frame to a service position behind the frame, in accordance with some embodiments.

FIGS. 22A, 22B, and 22C are schematic, perspective views of a mechanism for moving an RF bay FRU from an installed position on the frame to a service position at a side of the frame, in accordance with some embodiments.

### DETAILED DESCRIPTION

### Overview of a Personal Communication Structure (PCS)

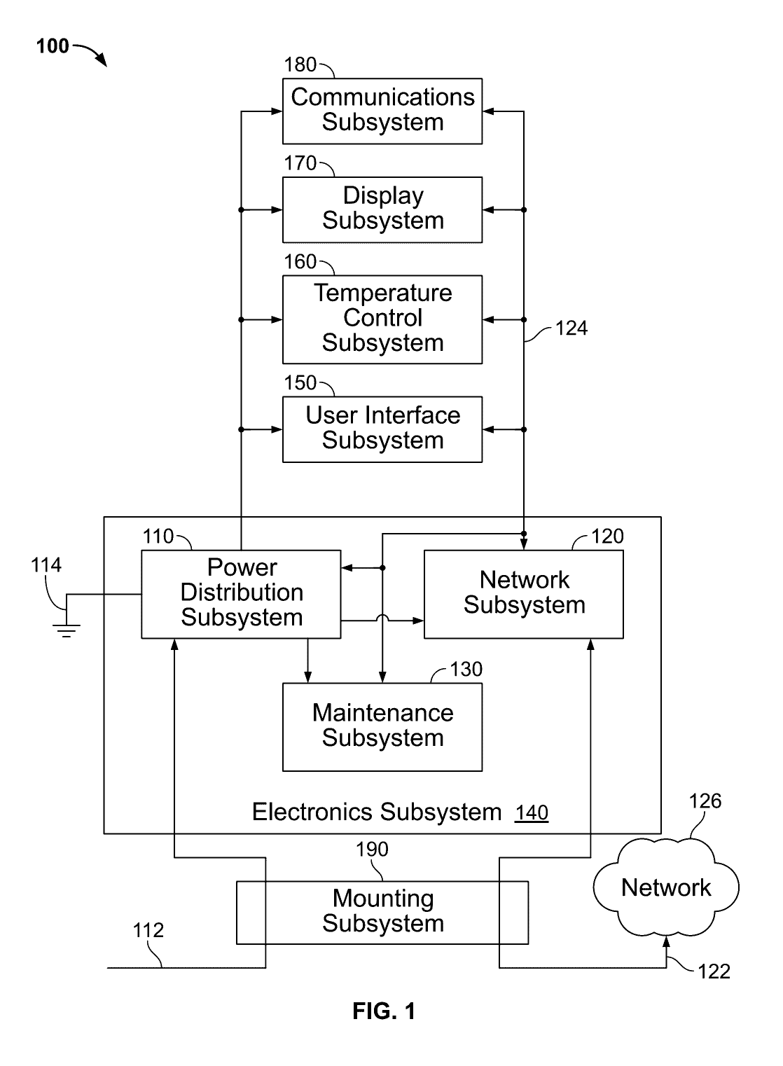

FIG. 1 illustrates a personal communication structure (PCS) 100, according to some embodiments. PCS 100 enhances access to communication networks in public or semi-public places. In some embodiments, PCS 100 includes an electronics subsystem 140, a user interface subsystem 150, a temperature control subsystem 160, a display subsystem 170, a communications subsystem 180, and/or a mounting subsystem 190. Electronics subsystem 140 may include a power distribution subsystem 110, a network subsystem 120, and/or a maintenance subsystem 130. These and other components of PCS 100 are described in further detail below.

Power distribution subsystem 110 distributes electrical power to components of PCS 100. Power distribution subsystem 100 may provide power to network subsystem 120, maintenance subsystem 130, other components of electronics subsystem 140, user interface subsystem 150, temperature control subsystem 160, display subsystem 170, and/or communications subsystem 180. Power distribution subsystem 110 may distribute power provided by any suitable power source(s) including, without limitation, batteries, solar panels, a power line 112 coupled to a power grid, etc. In some embodiments, power distribution subsystem 110 includes one or more power converters operable to convert power from one form (e.g., AC power) into another form (e.g., DC power) suitable for the PCS's components. In some embodiments, power distribution subsystem 110 includes one or more voltage level converters operable to change the voltage level of a signal to a level compatible with a component of the PCS. The ground terminal of the power distribution subsystem 110 may be coupled to a reference potential 114 via the chassis of the PCS or via any other suitable path.

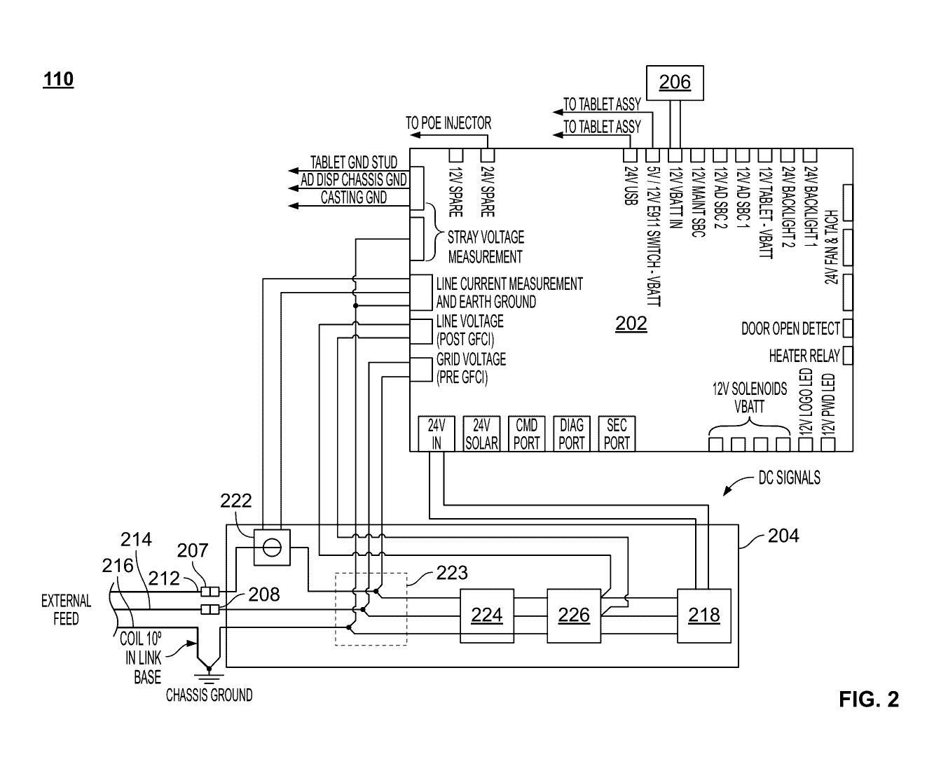

FIG. 2 shows a schematic of a power distribution subsystem 110, according to some embodiments. In some embodiments, power distribution subsystem (PDS) 110 includes a power conversion system 204, a power distribution board 202, and a battery 206. The inputs to power conversion system 204 include AC power supply signals (e.g., 120 VAC at 60 Hz) carried on a hot line 212, a neutral line 214, and a ground line 216. In some embodiments, the hot line 212 and neutral line 214 may be coupled to power conversion system 204 by quick disconnect devices 207 and 208, respectively, whereby the hot and neutral lines may be safely disconnected from power distribution subsystem 110 if the PCS is separated from its footing. Ground line 216 may be coupled to a ground terminal of the PCS 100. Power conversion system 204 processes the AC power supply signals and converts the processed signals into DC power supply signals. In some embodiments, power conversion system 204 includes a current transformer 222, AC power distribution unit 223, ground-fault circuit interrupter 224 (e.g., circuit breakers), AC line filter 226, and rectifier 218. Rectifier 218 may function as a DC power supply (e.g., a 24 V, 75 A, 2 kW DC power supply). As can be seen in FIG. 2, the outputs of various components of power conversion system 204 may be provided as inputs to power distribution board 202.

Power distribution board 202 may detect power system faults and distribute DC power signals to other components of the PCS. In some embodiments, power distribution board 202 uses the AC signals provided by power conversion system 204 to perform fault detection (e.g., ground fault detection, stray voltage detection, etc.). In some embodiments, power distribution board 202 uses the DC power supply signals provided by power conversion system 204 and/or battery 206 to produce DC power supply signals at various voltage levels (e.g., 5V, 12V, and 24V DC), and distributes those DC power supply signals to suitable components of the PCS 100.

In some embodiments, power distribution system DC power signals can be switched on and off. As those skilled in the art can appreciate, staggered activation of high-power devices (e.g., one or more components of display subsystem 170) reduces in-rush current demand on power supply 218. In some embodiments, the power distribution subsystem 110 is able to measure output current and can shut off power supply signals when the device reaches an over-current threshold. When a device causes over-current and “trips” the output, an error message may be sent to a maintenance center, indicating that the PCS requires servicing.

Battery 206 may provide backup power for components of PCS 100, including but not limited to user interface subsystem 150, which may implement emergency communication (e.g., E911) functionality. In some embodiments, power distribution board 202 may charge battery 206 (e.g., at 24 VDC) when power conversion system 204 is producing DC power and PCS 100 is not using all the available DC power. In some embodiments, a solar charging system may charge battery 206 during power outages or at other times.

In some embodiments, the power distribution subsystem 110 can detect whether the ground-fault circuit interrupter 224 has tripped. The ability to detect activation of the ground-fault circuit interrupter 224 can facilitate maintenance of the PCS. For example, while on back-up battery power, the PDS may determine whether AC power is lost (e.g., by sensing whether AC power supply signals are present) or the ground-fault circuit interrupter 224 has tripped. A suitable message can then be sent to the maintenance center, indicating, for example, whether the PCS requires service.

Returning to FIG. 1, network subsystem 120 controls communication on a network 124 within PCS 100, and communication between internal network 124 and a network 126 external to the PCS. In some embodiments, network subsystem 120 uses network 124 to communicate with power distribution system 110, maintenance subsystem 130, user interface subsystem 150, temperature control subsystem 160, display subsystem 170, and/or communications subsystem 180. The nodes of network 124 may be arranged in one or more suitable network topologies, including, without limitation, a bus (e.g., with network subsystem 120 as the bus controller), star network (e.g., with network subsystem 120 as the central hub), ring network, mesh network, tree network, point-to-point network, etc. Network 124 may be implemented using one or more suitable communication technologies, including, without limitation, Ethernet, DVI (Digital Visual Interface), HDMI (High-Definition Multimedia Interface), USB (Universal Serial Bus), SMB (System Management Bus), I2C (Inter-Integrated Circuit) bus, VGA (Video Graphics Array), SCSI (Small Computer System Interface), SPI (Serial Peripheral Interface) bus, LVDS (low-voltage differential signaling), etc.

Network subsystem 120 may send and receive any suitable data. For example, network subsystem 120 may control the operation of other components of PCS 100 by sending control data to the PCS's subsystems. Network subsystem 120 may forward commands received from a suitable source, including, without limitation, other PCS subsystems and/or network 126. As another example, network subsystem 120 may send operand data to components of PCS 100 for processing by those components (e.g., data to be displayed by display subsystem 170 or user interface subsystem 150, data to be transmitted by communications subsystem 180, etc.).

In some embodiments, network subsystem 120 communicates with network 126 via data link 122. Data link 122 may be implemented using a suitable communications line, including, without limitation, an Ethernet cable, coaxial cable, or optical fiber. In some embodiments, network subsystem 120 may include a signal conversion device adapted to convert the signals received on data link 122 from one form (e.g., optical signals) into another form (e.g., electrical signals).

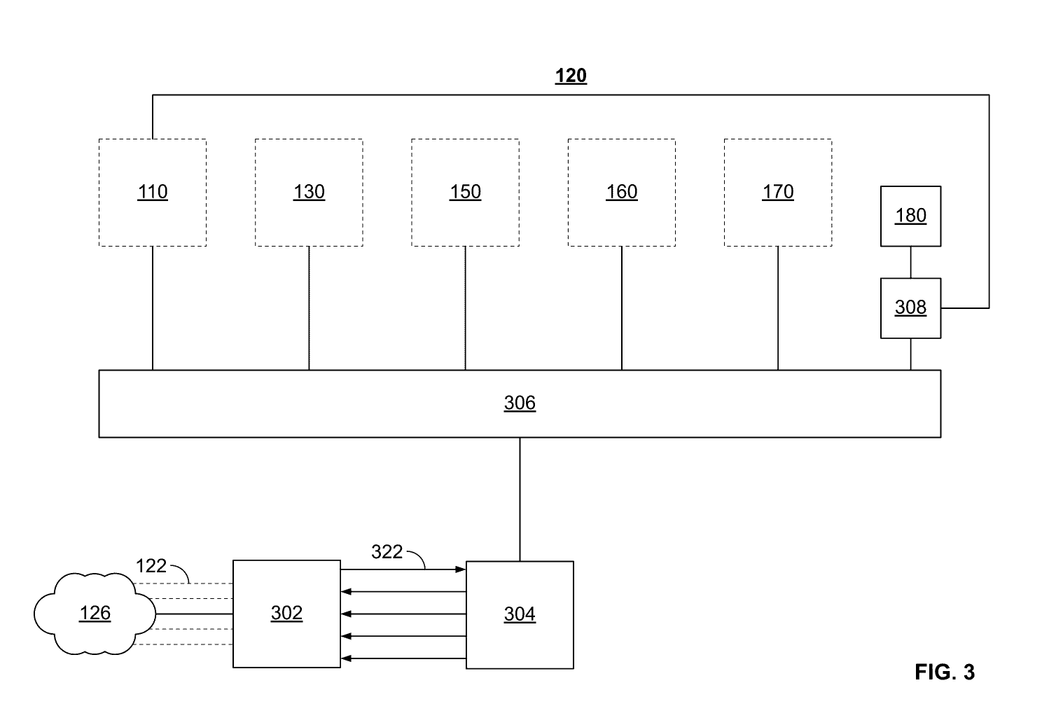

FIG. 3 shows a schematic of a network subsystem 120, in accordance with some embodiments. In one embodiment, network subsystem 120 includes a fiber junction box 302, a service delivery switch 304, and a network switch 306. In the example of FIG. 3, data link 122 includes one or more optical fibers. Fiber junction box 302 may optically couple the optical fibers of data link 122 to one or more internal optical fibers 322. In some embodiments, fiber junction box 302 includes one or more quick disconnect devices, whereby the optical fibers of data link 122 may be protected from damage if PCS 100 is separated from its footing. Service delivery switch 304 may convert the optical signals received on optical fibers 322 into electrical signals representing network traffic (e.g., Ethernet packets), and provide that network traffic to network switch 306. Likewise, service delivery switch 304 may convert the network traffic (e.g., Ethernet packets) received from network switch 306 into optical signals, and provide those optical signals to fiber junction box 302. Network switch 306 may switch network traffic between PCS subsystems, or between a PCS subsystem and network 126. In some embodiments, network switch 306 is an Ethernet switch. Network switch 306 may be powered by power distribution subsystem 110.

In some embodiments, network subsystem 120 includes a power-over-Ethernet (POE) injector 308. The POE injector 308 may provide power to one or more PCS subsystems, including, without limitation, communications subsystem 180.

Returning to FIG. 1, maintenance subsystem 130 runs maintenance diagnostics on components of PCS 100. In some embodiments, maintenance subsystem 130 performs tests on the PCS's components and/or initiates self-tests of the PCS's components. Such tests may be performed periodically (e.g., daily, weekly, monthly, etc.), intermittently, randomly or at other suitable times. Alternatively or in addition, components of PCS 100 may perform such tests in response to commands received via network subsystem 120 (e.g., commands issued by a PCS operator via network 126 or via communications subsystem 180), or in response to other suitable events.

Based on the results of such tests, maintenance subsystem 130 may determine whether a tested component is operating properly. If a tested component is not operating properly, maintenance subsystem 130 may output data describing the component's malfunction (e.g., transmit an error code to a PCS operator via network 126 or communications subsystem 180, display an error message via display subsystem 170 or user interface subsystem 150, etc.), take action to resolve the malfunction (e.g., reboot the malfunctioning component), turn off power to the faulty component or to the entire PCS (e.g., if the malfunction presents a safety hazard), etc.

In some embodiments, maintenance subsystem 130 may be adapted to control or adjust the operation of power distribution subsystem 110, for safety purposes or other suitable purposes. As described above, if a safety hazard is detected, maintenance subsystem 130 may control power distribution subsystem 110 to deactivate the PCS 100 or the unsafe component(s). Alternatively, maintenance subsystem 130 may control power distribution subsystem 110 to “power cycle” or “reboot” a malfunctioning component.

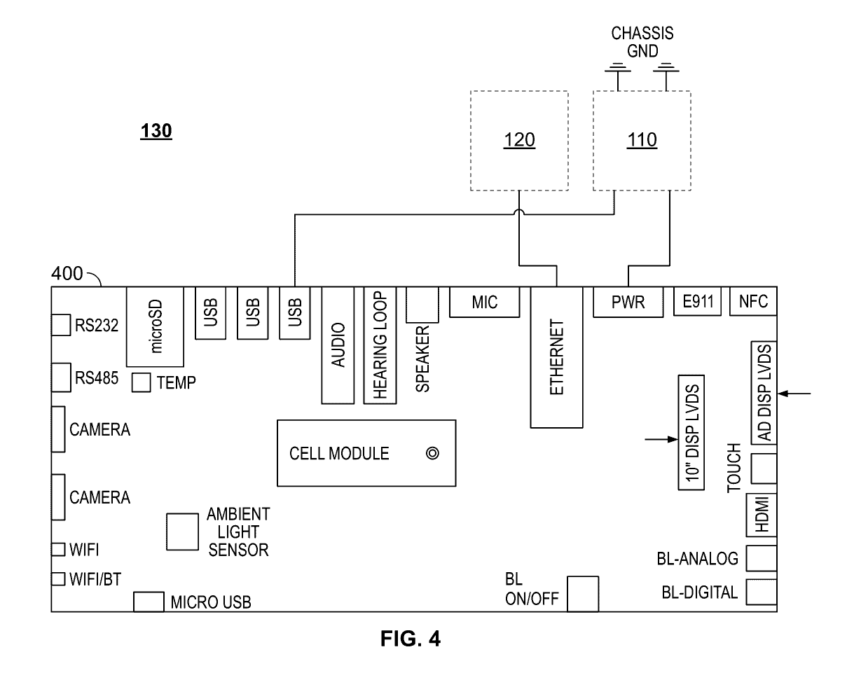

FIG. 4 shows a schematic of a maintenance subsystem 130, in accordance with some embodiments. In various embodiments, maintenance subsystem 130 includes one or more processing devices 400. The processing device(s) may include, without limitation, a microprocessor, microcontroller, small-board computer, system on a chip (SoC) (e.g., Qualcomm Snapdragon, Nvidia Tegra, Intel Atom, Samsung Exynos, Apple A7, Motorola X8, etc.), or other suitable processing device. The processing device(s) 400 may communicate with other components of PCS 100 via network subsystem 120 to perform maintenance tasks, or for other suitable purposes. In some embodiments, processing device(s) 400 are powered by power distribution subsystem 110.

Returning to FIG. 1, in addition to power distribution subsystem 110, network subsystem 120, and/or maintenance subsystem 130, electronics subsystem 140 may include other components. In some embodiments, electronics subsystem 140 includes one or more illumination controllers, which control illumination of one or more lights coupled to or proximate to the PCS. When lit, the lights controlled by the illumination controller may illuminate user interface subsystem 150 or other portions of PCS 100. In some embodiments, electronics subsystem 140 includes one or more sensor controllers, which control one or more sensor devices (e.g., microphones, cameras, ambient light sensors, pressure sensors, voltage sensors, environmental sensors, accelerometers, etc.). Such sensors may be used for any suitable purpose, including, without limitation, adjusting the brightness of displays and/or lights based on ambient lighting, surveilling the region proximate to the PCS (e.g., when an attempt to gain unauthorized access to the PCS is detected), etc.

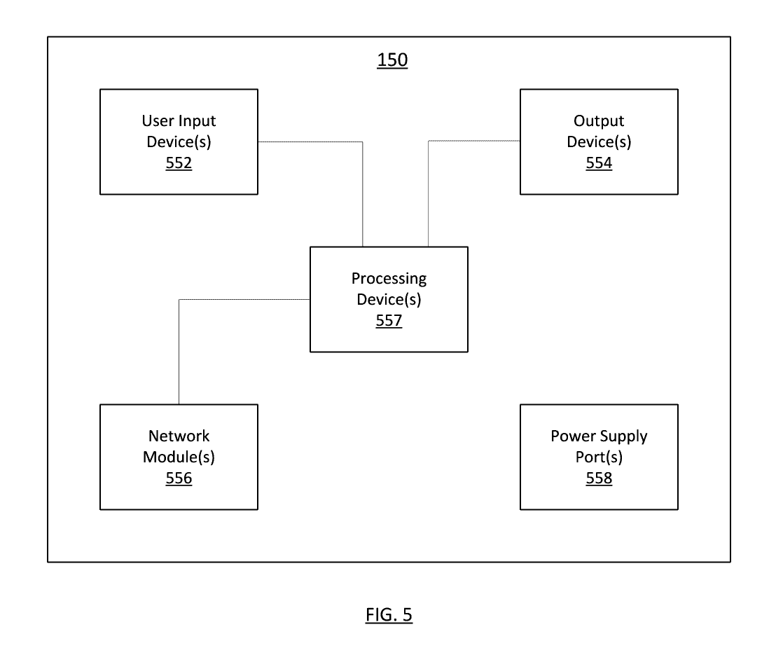

User interface subsystem 150 provides an interactive user interface, which may be used to access a communication network. Referring to FIG. 5, user interface subsystem 150 may include one or more user input devices 552, output devices 554, network modules 556 (e.g., network interface controllers, wireless transceivers, etc.), processing devices 557, and/or power supply ports 558. The user input device(s) 552 may include, without limitation, a touchscreen, touchpad, keyboard, keypad, trackball, one or more microphones, camera, buttons, switches, etc. The output device(s) 554 may include, without limitation, a display unit (e.g., touchscreen, LCD display, etc.), light(s), speaker(s), audio jack(s) (e.g., headset jacks, including microphone), etc. The one or more network modules 556 may include, without limitation, a 3G mobile network transceiver, 4G mobile network transceiver, LTE mobile network transceiver, Wi-Fi transceiver, RFID reader, Bluetooth transceiver, Near Field Communication (NFC) transceiver, Ethernet adapter, etc. In some embodiments, at least one of the network modules 556 may be configured to access network 126 via network subsystem 120 or to access a communication network via communications subsystem 180. The one or more processing devices may include, without limitation, a microprocessor, microcontroller, small board computer, or system on a chip (SoC) (e.g., Qualcomm Snapdragon, Nvidia Tegra, Intel Atom, Samsung Exynos, Apple A7, Motorola X8, etc.). The one or more power supply ports 558 may include, without limitation, one or more USB charging ports, a two-prong or three-prong AC power outlet (e.g., providing current limited AC power at 120 V, 60 Hz), etc.

User interface subsystem 150 may enhance users' access to communication networks in several ways. In some embodiments, user interface subsystem 150 may provide users access to communication networks (e.g., the Internet) via network module(s) 556. For example, a user may provide inputs via user input device(s) 552 to control a web browser or other network-based application executing on processing device(s) 557, which may access a communication network via network module(s) 556. The data obtained from the communication network may be processed by processing device(s) 557 and provided to the user via output device(s) 554. As another example, a user may connect a computing device (e.g., a mobile computing device) to user interface subsystem 150 via a network module 556 (e.g., a Wi-Fi access point), and access a communication network via another network module 556 (e.g., a mobile network transceiver), via communications subsystem 180, or via network 126. As yet another example, users may charge mobile computing devices via power supply port(s) 558, and access communication networks through the charged devices.

In some embodiments, PCS 100 includes an assisted listening unit that transmits the PCS's audio outputs to hearing assistance devices (e.g., hearing aids, Cochlear implants, etc.) within the assisted listening unit's range via a “hearing loop” (e.g., an “audio induction loop” or “audio-frequency induction loop”). The assisted listening unit may include a loop coil and a loop amplifier adapted to drive amplified signals into the loop coil, thereby creating a magnetic field that delivers the amplified signals to hearing assistance devices within the unit's range. The loop coil may be included in or located proximate to user interface subsystem 150, or disposed at another suitable location in, on, or near PCS 100.

In some embodiments, user interface subsystem 150 includes an interface for adjusting the assisted listening unit (e.g., for increasing or decreasing the signal strength or range of the assisted listening unit). The assisted listening unit's interface may include, without limitation, one or more buttons, dials, switches, and/or software-based interfaces. By adjusting the assisted listening unit, a user may control the range of the assisted listening unit and/or the volume of the audio output provided by the assisted listening unit.

In some embodiments, user interface subsystem 150 includes interface components for placing a phone call. User interface subsystem may implement the phone calls using voice-over-IP (VOIP) technology. The user's speech may be captured via the user interface subsystem's microphone, and the speech of other parties to the phone call may be provided via the user interface subsystem's speaker(s). In some embodiments, the user interface subsystem 150 permits users to place phone calls to emergency responders (e.g., E911 calls). The E911 calls may be placed using VOIP technology (e.g., via a network module 556 of user interface 150, via communications subsystem 180, or via network 126) or another suitable technology.

In some embodiments, the user input devices 552 include a microphone system, and the processing device 557 is able to perform noise cancellation on the microphone system. It can be appreciated that the PCS may be located in an environment with high levels of ambient street noise. The processing device 557 may perform a noise cancelling process that distinguishes the user's speech from the background noise and removes at least some of the background noise from the audio stream. When a user plugs in a headset that contains a microphone, the noise cancellation technique may also detect and remove background noise picked up by the headset's microphone.

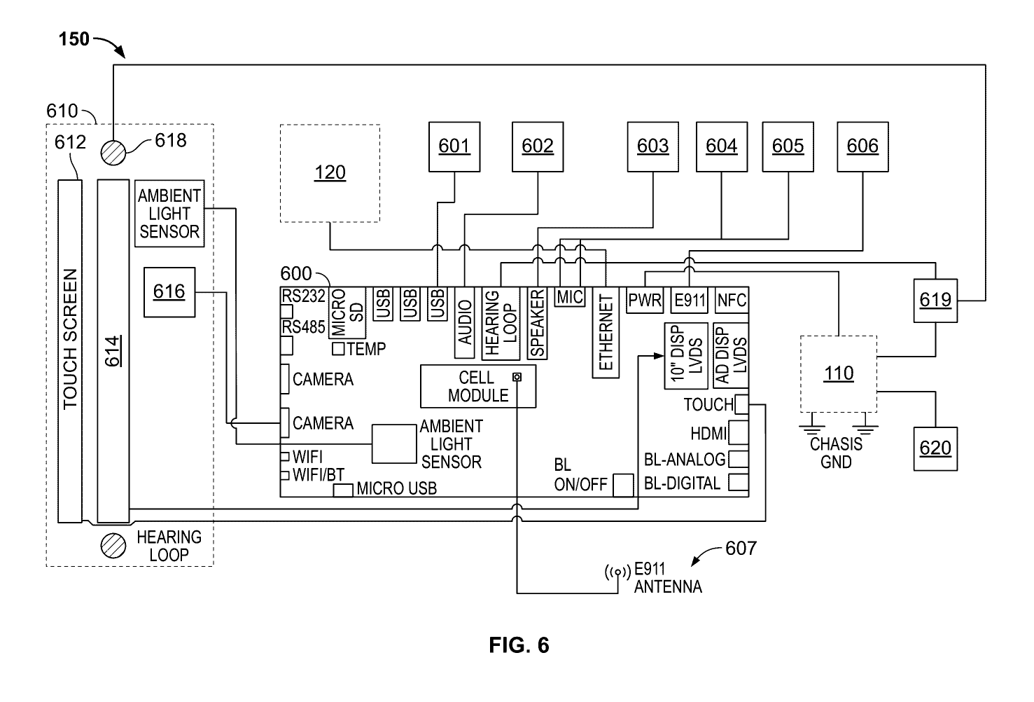

FIG. 6 shows an exemplary schematic of the user interface subsystem 150, in accordance with some embodiments. In some embodiments, user interface subsystem 150 includes one or more processing devices 600. The processing device(s) 600 may include, without limitation, a microprocessor, microcontroller, small-board computer, system on a chip (SoC) (e.g., Qualcomm Snapdragon, Nvidia Tegra, Intel Atom, Samsung Exynos, Apple A7, Motorola X8, etc.), or other suitable processing device. The processing device(s) 600 may communicate with other components of PCS 100 via network subsystem 120. In some embodiments, processing device(s) 600 are powered by power distribution subsystem 110.

In the example of FIG. 6, user interface subsystem 150 includes a keypad 601, headset jack 602, speaker 603, two microphones (604, 605), and an E911 button 606, all of which are coupled to the processing device(s) 600. Processing device(s) 600 may be adapted to initiate an E911 communication when E911 button 606 is pressed, and to send and receive E911 messages via a wireless communication module 607 (e.g., a 3G, 4G, or LTE mobile network transceiver, including a suitable antenna, which may be located proximate to the top of the PCS).

In some embodiments, the E911 button contains an indicator. One example of the indicator is an illumination ring. The illumination ring may help a user to locate the button at night, and/or may flash when a user presses the button to indicate a E911 call is in progress.

In the example of FIG. 6, user interface subsystem 150 includes a touchscreen 612, display 614, camera 616, hearing loop coil 618, hearing loop amplifier 619, and USB charging port(s) 620. In some embodiments, the touchscreen 612, display 614, camera 616, and hearing loop coil 618 may be packaged together in a tablet computing device 610. The USB charging port(s) 620 and hearing loop amplifier 619 may be powered by power distribution subsystem 110.

Returning to FIG. 1, temperature control subsystem 160 controls the temperature within PCS 100. For example, temperature control subsystem 160 may cool the components of PCS 100. Some of the PCS's components generate heat and the PCS 100 may absorb heat from its environment (e.g., via radiation or convection), particularly when the ambient temperature is high or the PCS is exposed to direct sunlight. Extreme heat can interfere with the operation of the PCS or even permanently damage some of the PCS's components.

Alternatively or in addition, temperature control system 160 may, under appropriate conditions, heat the components of PCS 100. Some PCSs may be located in cold environments (e.g., outdoors in regions with cold ambient temperatures). Like extreme heat, extreme cold can interfere with the PCS's operation or damage its components.

Temperature control subsystem 160 may include one or more components suitable for heating and/or cooling the PCS. In some embodiments, temperature control subsystem 160 includes one or more fans operable to circulate ambient air through the PCS, which can cool the PCS. In some embodiments, the PCS 100 includes one or more heat sinks, and the ambient air circulated by temperature control subsystem 160 passes proximate to the heat sink(s). In some embodiments, temperature control subsystem 160 includes one or more fans operable to recirculate air in portions (e.g., airtight compartments) of PCS 100, which can facilitate the transfer of heat from those portions of the PCS to other regions of the PCS and/or to the ambient environment. The fans may be single-speed fans or variable-speed fans. In some embodiments, temperature control subsystem 160 includes one or more heaters, which can heat the PCS. In some embodiments, one or more fans and/or heaters are located apart from temperature control subsystem 160, but controlled by the temperature control subsystem.

Temperature control subsystem 160 may control the PCS's temperature by controlling the operation of the fan(s) and/or heater(s). In some embodiments, temperature control subsystem 160 controls the PCS's temperature based, at least in part, on the temperature inside or in an area proximate to the PCS. Temperature control subsystem 160 may obtain temperature information regarding the temperature in or near PCS 100 from one or more temperature sensors. The temperature sensors may be located inside the PCS, on an outer surface of the PCS, proximate to the PCS, and/or in any other suitable location. Temperature control subsystem 160 may include one or more sensor drivers that can activate the sensor(s) and obtain temperature measurements from the sensor(s). Alternatively or in addition, temperature control subsystem may obtain temperature information regarding the temperature in the vicinity of the PCS from a suitable source (e.g., a website) via a communication network (e.g., network 126).

In some embodiments, the temperature control system 160 adds or removes active fans (e.g., switches fans on or off) in specific areas of the PCS based on the temperature sensor information. For example, active fans may be added when the ambient temperature is high (e.g., above a threshold). Conversely, active fans may be removed when the ambient temperature is low (e.g., below a threshold) to reduce power usage. The fans may be organized in addressable groups to facilitate addition and removal of active fans.

In some embodiments, the temperature control subsystem 160 uses a feedback-based control system (e.g., a feedback loop) to control the speeds of the fans. The fans may include tachometers, and the tachometer outputs may be fed back to the temperature control subsystem, which may use the tachometer outputs to determine the speeds of the fans. In addition to adding and removing active fans, the temperature control subsystem 160 may increase the speeds of the fans as the internal temperature increases or decrease the speeds of the fans as the temperature decreases.

In some embodiments, the temperature control subsystem 160 uses the fan tachometer output to determine whether a fan fault has occurred. For example, the temperature control subsystem 160 may detect a fan fault when the tachometer output indicates that there is little or no fan rotation (e.g., the rate of fan rotation is below a threshold). When a fan fault is detected, the PCS may notify the maintenance center of the fault, so the PCS can be serviced to replace or repair the faulty fan.

In some embodiments, temperature control subsystem 160 controls the PCS's temperature based on environmental information, which may include temperature information and/or other information associated with the PCS's environment. For example, environmental information may include sunlight information indicating whether the PCS is exposed to direct sunlight. Sunlight information may be obtained from a camera or other suitable optical sensor. Alternatively or in addition, environmental information may include humidity information indicating the humidity levels in the PCS's environment, time-of-day information indicating the current time at the PCS's location, weather information indicating the weather in the PCS's environment, etc.

Based on the environmental information, temperature control subsystem 160 may control the fan(s) and/or heater(s) to adjust the PCS's temperature. In some embodiments, temperature control subsystem 160 may activate one or more heaters when the PCS's temperature is below a lower threshold temperature, and/or activate one or more fans when the PCS's temperature is above an upper threshold temperature. In some embodiments, the number of heater units and/or fans activated by temperature control subsystem 160 is determined based on the environmental information. In some embodiments, the settings of the activated heaters and/or fans (e.g., the fan speeds, the heater temperatures, etc.) may be determined based on the environmental information. In some embodiments, if the temperature in the PCS is determined to be outside a safe operating range, temperature control subsystem may instruct power distribution subsystem 110 to deactivate the PCS or at least one component thereof.

Display subsystem 170 includes one or more display modules, each of which includes at least one display device. The display device may include, without limitation, a liquid crystal display (LCD), light-emitting diode (LED) display, organic light-emitting diode (OLED) display, cathode ray tube (CRT), electroluminescent display (ELD), electronic paper/electronic ink display (e.g., a bi-stable or multi-stable electrophoretic or electro-wetting display), plasma display, thin-film transistor (TFT) display, 3D display (e.g., volumetric display, holographic display, integral imaging display, compressive light field display, etc.), stereoscopic display, etc. In some embodiments, display subsystem 170 includes two display modules disposed on opposite sides of the PCS, such that the modules' display devices face in opposite directions.

A display device may display suitable information, including, without limitation, news information, weather information, emergency information (e.g., instructions for dealing with an emergency, evacuation routes, etc.), travel information (e.g., traffic conditions, road conditions, speed limits, alternative route information, public transit schedules, locations of and/or directions to public transportation facilities, etc.), tourism information (e.g., locations of and/or directions to popular tourist attractions), advertisements, etc. The displayed information may be displayed in one or more suitable formats, including, without limitation, text, still images, and/or video. Display subsystem 170 may include one or more processing devices adapted to control the display of information by the display device(s). For example, each display module may include a processing device adapted to control the display module's display device.

In some embodiments, display subsystem 170 includes one or more cameras. For example, each display module may include one or more cameras. Display subsystem 170 may use the cameras to determine the ambient light levels, and may adjust the brightness of the display device(s) accordingly. For example, if the ambient light level at the PCS is high (e.g., because the sun is shining on the PCS), display subsystem 170 may increase the brightness of the display(s) (e.g., by increasing the brightness of the display backlight(s)), so that the displayed information is readily viewable by onlookers or passers-by. On the other hand, if the ambient light level at the PCS is low, display subsystem 170 may decrease the brightness of the display(s), to reduce the display subsystem's power usage and/or heat generation. In some embodiments, the brightness levels of the PCS's displays may be controlled independently.

Alternatively or in addition, display subsystem 170 may use the cameras to obtain information about “potential viewers” (e.g., people viewing the PCS, viewing a display device of the PCS, using the PCS, and/or in the vicinity of the PCS). In some embodiments, display subsystem 170 may determine, based on images of the area proximate to the PCS (e.g., images acquired by the PCS's camera(s)), a potential viewer's apparent demographic information, including, without limitation, age, sex, race/ethnicity, etc. In some embodiments, display subsystem 170 may use facial-recognition techniques to determine a potential viewer's identity.

Display subsystem 170 may use information about the PCS's potential viewers to select the information to be displayed by the display device(s) (e.g., to select advertisements for display based on the identities or demographics of the potential viewers). Alternatively or in addition, display subsystem 170 may track the identities and/or demographics of the potential viewers who have been in the vicinity of the PCS when particular advertisements have been displayed. Tracking information about potential viewers of advertisements and/or controlling the display of advertisements based on information about the potential viewers may increase the value of the PCS's advertising impressions to potential advertisers.

Display subsystem 170 may obtain information about a potential viewer from the potential viewer, from analysis of images of the potential viewer, and/or from the potential viewer's computing device (e.g., smartphone). For example, a potential viewer who connects to a communication network through a PCS 100 (e.g., via user interface subsystem 150 or via the user's computing device) may provide authentication data (e.g., a username, password, and/or other credentials), and the PCS may use that authentication data to access the potential viewer's account information, which may identify the potential viewer and/or provide information about the potential viewer (e.g., the potential viewer's attributes and/or interests). The potential viewer may have provided such information when registering for access to the PCS (or set of PCSs), or the PCS may have inferred such information based on the potential viewer's activities on the communication network.

Even if potential viewers do not register for PCS access, information about a potential viewer's attributes and/or interests can still be inferred based on the potential viewer's activities, and this information can be tracked in connection with information identifying the potential viewer's computing device (e.g., a mobile device's phone number, mobile equipment identifier (MEID), or unique device identifier (UDID); a computing device's media access control (MAC) address; etc.). In some embodiments, a PCS 100 may identify a potential viewer or attributes thereof based on identifying information transmitted by the potential viewer's computing device when the computing device is within range of the PCS, even if the computing device is not connected to a network via the PCS 100.

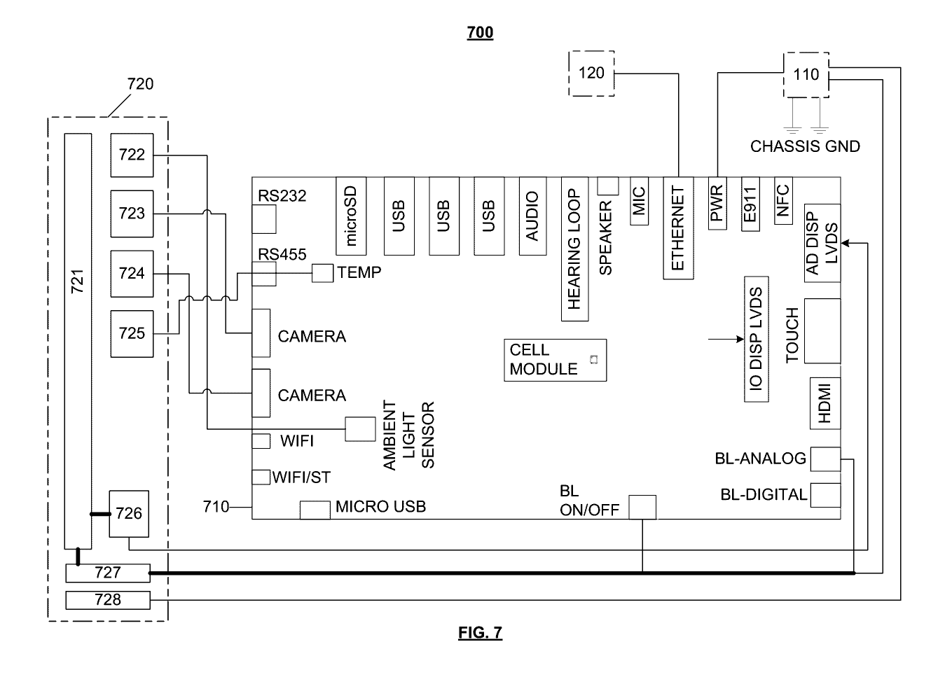

FIG. 7 is a schematic of a display module 700, in accordance with some embodiments. In some embodiments, a PCS 100 includes two display modules 700. In some embodiments, a display module 700 includes one or more processing device(s) 710. Each processing device 710 may include, without limitation, a microprocessor, microcontroller, small-board computer, system on a chip (SoC) (e.g., Qualcomm Snapdragon, Nvidia Tegra, Intel Atom, Samsung Exynos, Apple A7, Motorola X8, etc.), or other suitable processing device. The processing device(s) 710 may communicate with other components of PCS 100 via network subsystem 120. In some embodiments, each processing device 710 is powered by power distribution subsystem 110. In the example of FIG. 7, display module 700 also includes a display device 720. Display device 720 may include a display panel 721, ambient light sensor 722, two cameras (723, 724), temperature sensor 725, frame rate controller 726, power/backlight controller 727, and one or more fans 728.

In some embodiments, the processing device 710 is able to read the ambient light sensor 722 and send a control signal to the power/backlight controller 727. One example of the control signal is a pulse width modulated (PWM) output. In response to the ambient light sensor 722 detecting the presence of high ambient light, the duty cycle of the PWM signal may be increased, thereby causing the power/backlight controller to increase the backlight brightness, so that the display image is viewable in bright sunlight. Those skilled in the art can appreciate that the PWM control signal may be digital or converted to an analog output via a digital to analog converter.

Returning to FIG. 1, communications subsystem 180 includes one or more communication modules. In some embodiments, the communication module(s) include one or more radio access nodes. The radio access node(s) may include small cells (e.g., low-power radio access nodes with ranges between roughly 10 m and 1-2 km, including, but not limited to, femtocells, picocells, and microcells), macrocells (e.g., radio access nodes with ranges of up to a few tens of kilometers), etc. The radio access node(s) may reduce congestion in mobile data networks (e.g., 3G, 4G, or LTE networks) by expanding network capacity and offloading traffic from more congested portions of the network to the portions of the network associated with the radio access node(s). In areas where mobile data networks are highly congested (e.g., portions of New York City, and particularly portions of Manhattan), deploying PCSs with radio access node(s) in an area where mobile data networks are congested may, in some embodiments, greatly reduce network congestion and improve quality of service for many network users.

In some embodiments, communications subsystem 180 includes at least one wireless access point. Computing devices may connect to the wireless access point using a suitable wireless adapter, including, without limitation, a Wi-Fi or WiMAX adapter. Through the wireless access point, communications subsystem 180 may provide access to a local area network (LAN) or wide area network (WAN) (e.g., network 126, or a 3G, 4G, or LTE network accessed via the communications subsystem's radio access node(s)). PCS operators may use the wireless access points to provide wireless broadband network access to individuals, subscribers, communities, etc. Use of the wireless access points may further improve the quality of service on mobile data networks by offloading some users from the mobile data networks to the wireless access point.

Returning to FIG. 1, mounting subsystem 190 includes a mounting device that releasably secures the PCS to a support (e.g., a footing). The mounting device may be adapted to break when a shear force above a predetermined value is applied to the mounting device, thereby allowing the PCS to move. Such releasable mounting can reduce the damage caused to people and property when an automobile collides with the PCS.

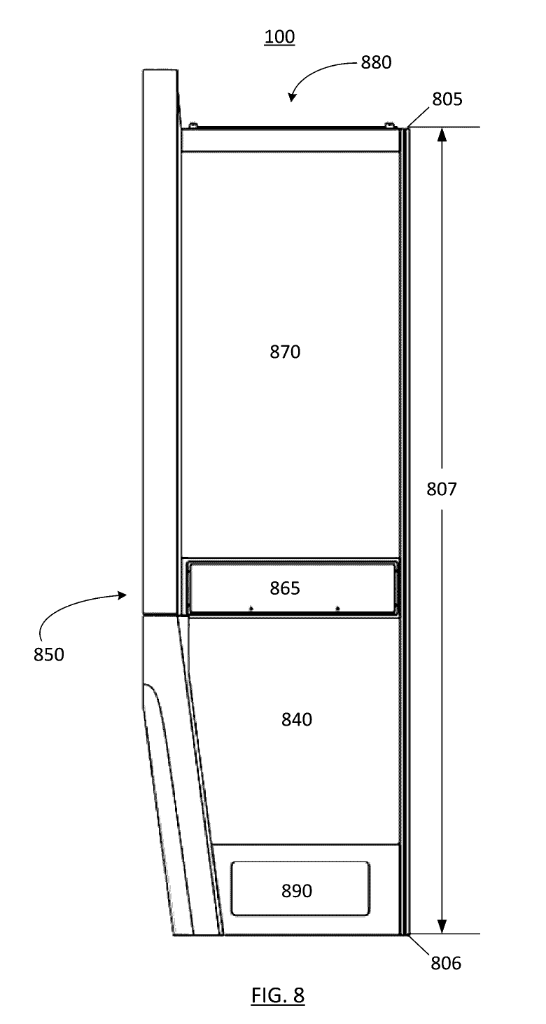

PCS 100 may include compartments and components of PCS 100 may be disposed in the compartments. FIG. 8 illustrates an arrangement of compartments of a PCS 100, according to some embodiments. For convenience, the PCS's top portion 805 and base portion 806 are identified in FIG. 8, as is the PCS's height 807.

In the example of FIG. 8, PCS 100 includes mounting compartment 890, electronics compartment 840, user interface compartment 850, air intake compartment 865, display compartment 870, and communications compartment 880. Electronics compartment 840 may enclose electronics subsystem 140. User interface compartment 850, display compartment 870, and communications compartment 880 may enclose user interface subsystem 150, display subsystem 170, and communications subsystem 180, respectively. In some embodiments, display compartment 870 may enclose, in addition to display subsystem 870, one or more heat sinks. Mounting compartment 890 may enclose at least a portion of a mounting subsystem 190.

Air intake compartment 865 may enclose at least portions of temperature control subsystem 160. In some embodiments, air intake compartment 865 may enclose one or more fans, which may draw ambient air into the air intake area. In some embodiments, the one or more fans may also draw air into the air intake area from electronics compartment 840. The fans may move the air through display compartment 870 (e.g., across one or more heat sinks), and the air may be discharged through an exhaust in communications compartment 880. In some embodiments, air intake compartment 865 may enclose one or more heaters.

In the example of FIG. 8, communications compartment 880 is located proximate to the top 805 of the PCS, display compartment 870 is disposed along an upper portion of the PCS and below communications compartment 880, and an air intake compartment 865 is located proximate to a middle portion of the PCS (in the direction of the PCS's height) and below display compartment 870. Mounting compartment 890 is located proximate a base 806 of the PCS, electronics compartment 840 is disposed along a lower portion of the PCS between mounting compartment 890 and air intake compartment 865, and user interface compartment 850 is disposed along a lower portion of the PCS adjacent to air intake compartment 865 and electronics compartment 840.

Embodiments of a PCS are not limited by the compartmentalization scheme illustrated in FIG. 8. A PCS may include none of the compartments illustrated in FIG. 8, any combination of the compartments illustrated in FIG. 8, and/or other compartments not illustrated in FIG. 8. In cases where a PCS includes a compartment illustrated in FIG. 8 (e.g., mounting compartment 890, electronics compartment 840, user interface compartment 850, air intake compartment 865, display compartment 870, or communications compartment 880), the location and/or shape of that compartment may differ from the location and/or shape of the corresponding compartment in FIG. 8. In some embodiments, a PCS may include a compartment that encloses two or more PCS subsystems that are enclosed by different compartments in the example of FIG. 8. In some embodiments, a PCS may include separate compartments enclosing respective portions of a PCS subsystem that is enclosed by a single compartment in the example of FIG. 8. In some embodiments, a PCS may include a compartment that encloses other compartments.

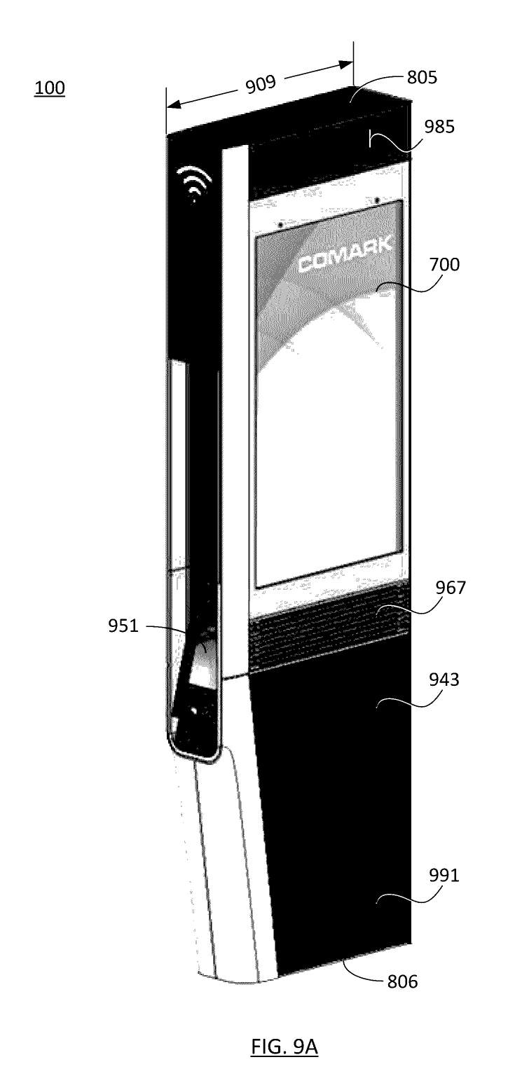

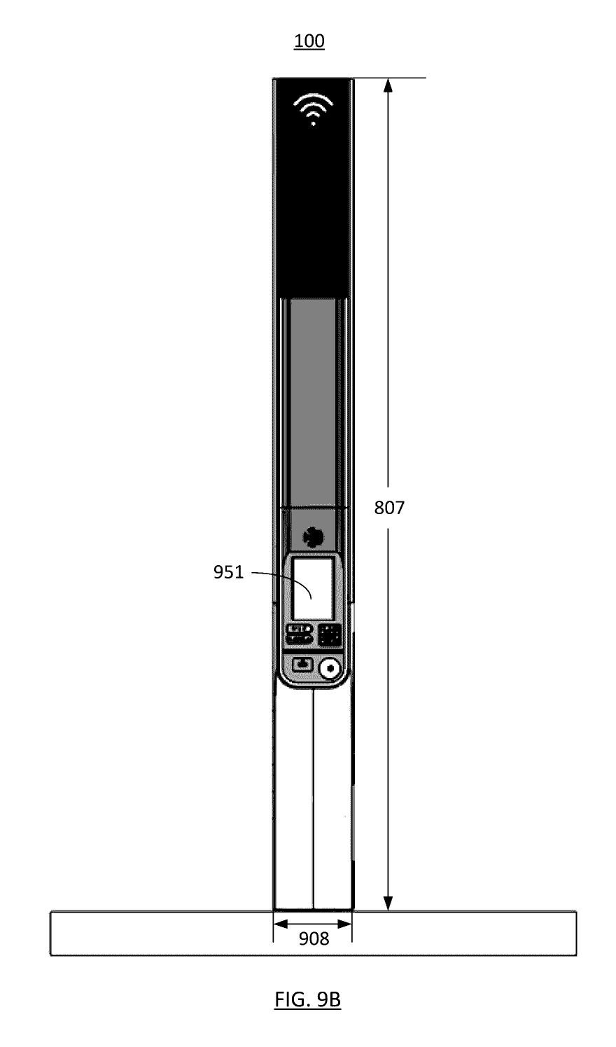

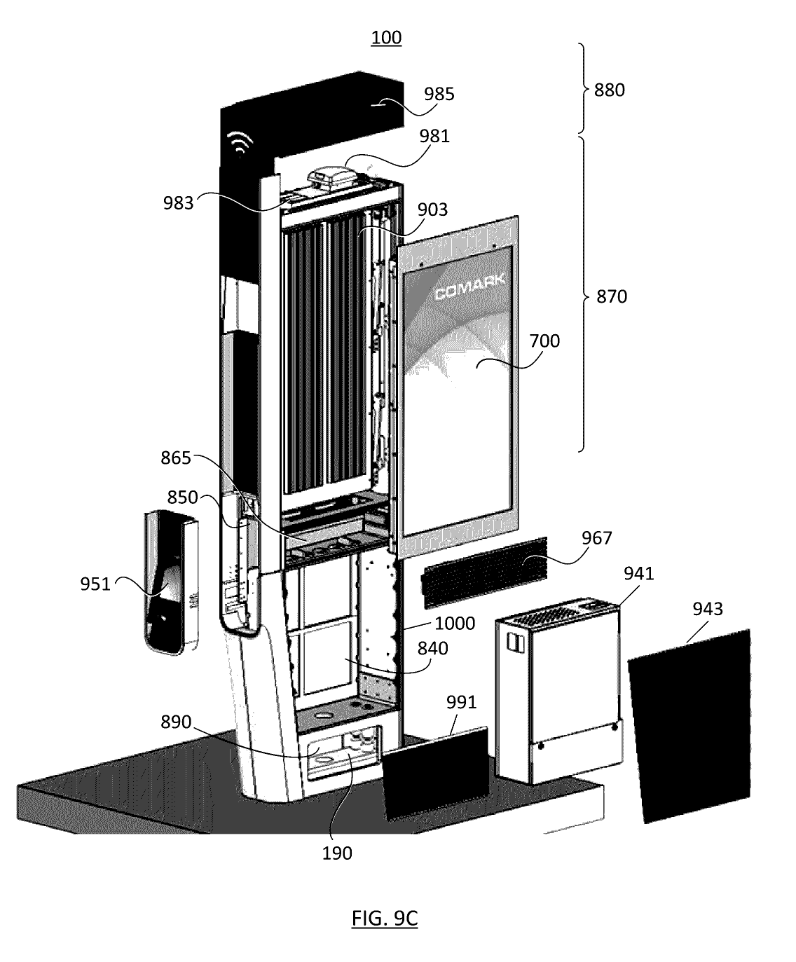

FIGS. 9A, 9B, and 9C show respective front perspective, side, and exploded front perspective views of a PCS 100, in accordance with some embodiments. For convenience, the PCS's top portion 805 and base portion 806 are identified in FIGS. 9A-9B, as are the PCS's height 807, width 908, and length 909.

As can be seen in FIG. 9C, PCS 100 may include a frame 1000. The frame 1000 is (or is part of) a structural system that supports the components of PCS 100. In some embodiments, the frame 1000 forms portions of the PCS's compartments (e.g., communications compartment 880, display compartment 870, air intake compartment 865, user interface compartment 850, electronics compartment 840, and mounting compartment 890).

As can further be seen in FIG. 9C, communications compartment 880 may include a radio access node 981, a wireless access point 983, and/or one or more antennas. The bottom of communications compartment 880 may be formed by a portion of frame 1000, and the top and sides of communications compartment 880 may be formed by a removable cap 985.

Display compartment 870 may include a heat sink 903 and a display module 700. In some embodiments, display compartment 870 includes a second display module (and, optionally, a second heat sink) arranged back-to-back (e.g., in parallel) with display module 700 and heat sink 903, such that display module 700 and the second display module face in opposite directions.

Air intake compartment 865 may include an air intake assembly 967. The air intake assembly 967 may include a grill, a filter, and a fan assembly. User interface compartment 850 may include a user interface device 951. The user interface device 951 may include a table computer, keypad, an emergency call button, microphone(s), speakers, and a mobile device charging port. Electronics compartment 840 may include an electronics cabinet 941, and may be formed by portions of frame 1000 and a cover panel 943. Mounting compartment 890 may at least partially enclose mounting subsystem 190, and may be formed by portions of frame 1000 and a cover panel 991.

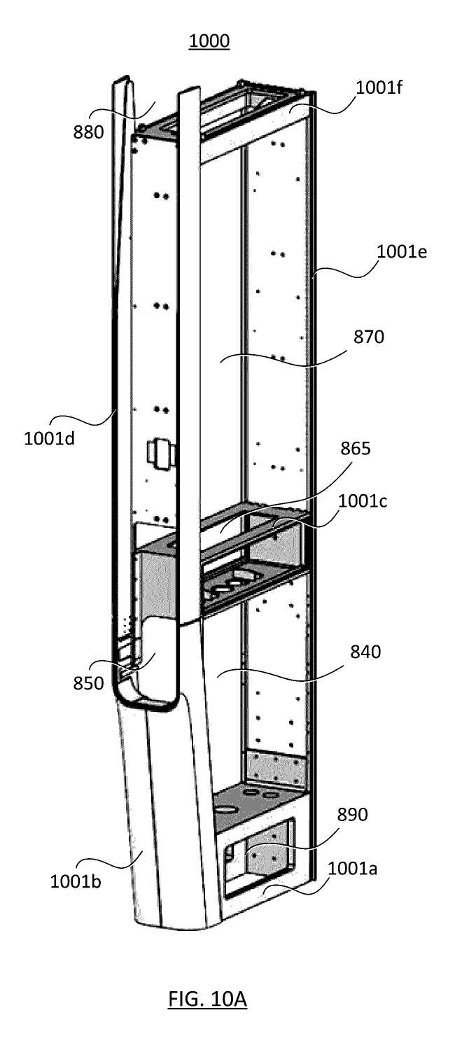

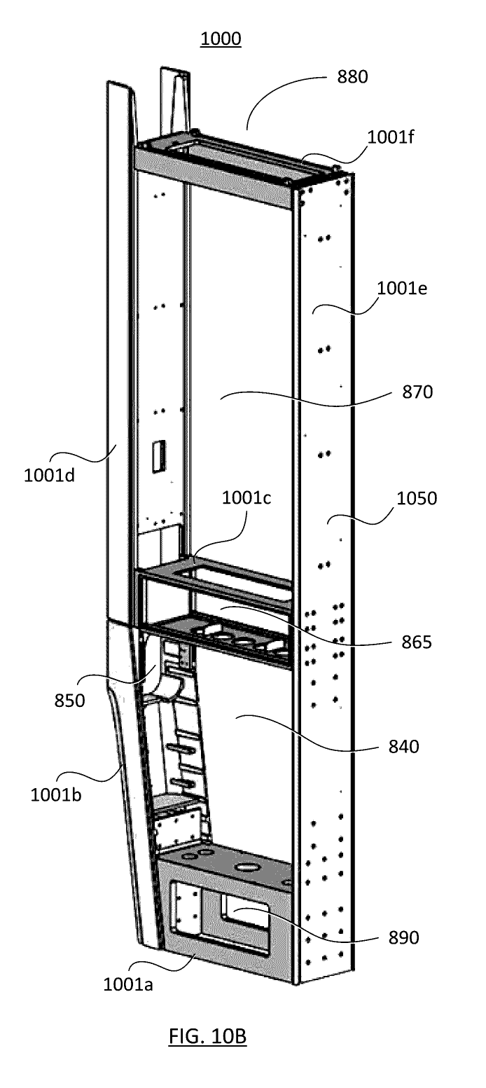

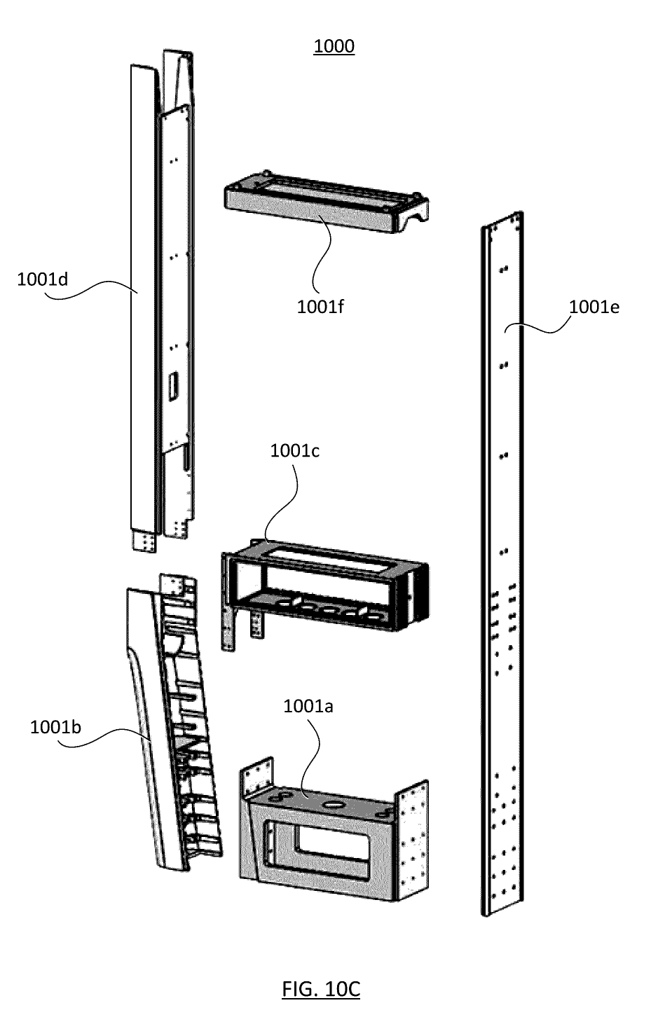

FIGS. 10A-10C show the frame 1000 of a PCS 100, according to some embodiments, and illustrate how the frame 1000 partially forms the PCS's compartments. In some embodiments, the frame 1000 is the frame of a monocoque structure, wherein the frame supports the components, forms the compartments and is also the outer face (or “skin”) of portions of the PCS (e.g., the user interface compartment 850 and the opposing side 1050 of the PCS). This approach may simplify construction by reducing the number of brackets, mounting accessories, part count, etc.

In another embodiment, the frame 1000 is that of a traditional structure, and the outer skins are attached to the frame. In such embodiments, the frame supports the components of the PCS, forms the compartments of the PCS, and acts as a rigid structural chassis. One advantage of this approach is field replaceability. If an outer skin is damaged (e.g., by vandalism or by ordinary wear and tear), the damaged skin can be replaced with a new skin. As long as the frame remains uncompromised, damaged outer skins can be removed, replaced, and (optionally) sent to a service facility for refurbishing. Refurbishing methods may include removing dents and/or scratches, sanding, texturing, reshaping, and/or re-painting. Skins that are not suitable for refurbishing (e.g., due to extensive damage) may be recycled and turned into new parts.

As can be seen in FIGS. 10A-10C, frame 1000 may include a bottom member 1001a, a lower front member 1001b, a cross-frame member 1001c, an upper front member 1001d, a rear member 1001e, and a top member 1001f. In the example of FIGS. 10A-10C, lower portions of lower front member 1001b and rear member 1001e are joined to opposite sides of bottom member 1001a. One side of cross-frame member 1001c is joined to an upper portion of lower front member 1001b and a lower portion of upper front member 1001d. The opposite side of cross-frame member 1001c is joined to rear member 1001e proximate to a midpoint between the rear member's top and base ends. The upper portions of upper front member 1001d and rear member 1001e are joined to opposite sides of top member 1001f.

In the example of FIGS. 10A-10C, top member 1001f and the upper portion of upper front member 1001d form a bottom and a side of communications compartment 880. Two sides of display compartment 870 are formed by upper front member 1001d and rear member 1001e, and the top and bottom of display compartment 870 are formed by top member 1001f and cross-frame member 1001c, respectively. Cross-frame member 1001c forms the top, bottom, and two sides of air intake compartment 865. User interface compartment 850 is formed in part by the bottom portion of upper front member 1001d, the top portion of lower front member 1001b, and a side of cross-frame member 1001c. Two sides of electronics compartment 840 are formed by lower front member 1001b and the lower portion of rear member 1001e, and the top and bottom of electronics compartment 840 are formed by cross-frame member 1001c and bottom member 1001a, respectively. Bottom member 1001a forms mounting compartment 890.

Embodiments of frame 1000 are not limited by the configuration shown in FIGS. 10A-10C. As can be seen in FIG. 11, which shows a front-perspective view of a portion of PCS 100, some embodiments of frame 1000 further include one or more cross-frame members 1001g coupled to upper front member 1001d and an upper portion of rear member 1001e to form an I-beam. In some embodiments, cross-frame member(s) 1001g may include one or more ribbed heat sinks 1161. A ribbed heat sink 1161 may include a substantially planar member 1163 and fins 1162 extending from the substantially planar member 1163 (e.g., in one or more directions substantially perpendicular to the surface of the substantially planar member).

Frame 1000 may facilitate cooling of the PCS's compartments. In some embodiments, one or more (e.g., all) members of frame 1000 may have relatively high thermal conductivity (e.g., average thermal conductivity of at least 90, 100, 110, or 120 Btu/(hr*° F.*ft)). When the temperature within a PCS compartment is greater than the ambient temperature in the area proximate to the PCS, the frame member(s) with relatively high thermal conductivity may function as heat sinks (including, but not limited to, cross-frame member(s) 1001g), such that heat from the compartments is transferred to the PCS's ambient environment through the frame member(s). The member(s) of frame 1000 with relatively high thermal conductivity may substantially consist of materials with relatively high thermal conductivity, including, without limitation, aluminum, thermal pyrolytic graphite, silicon carbide, etc. For example, one or more member(s) of frame 1000 may substantially consist of aluminum.

Members of frame 1000 may be manufactured using suitable techniques. In some embodiments, bottom member 1001a, lower front member 1001b, cross-frame member 1001c, cross-frame member(s) 1001g, and/or top member 1001f may be metal castings. In some embodiments, upper front member 1001d and/or rear member 1001e may be extruded metal, polymer, composite, etc.

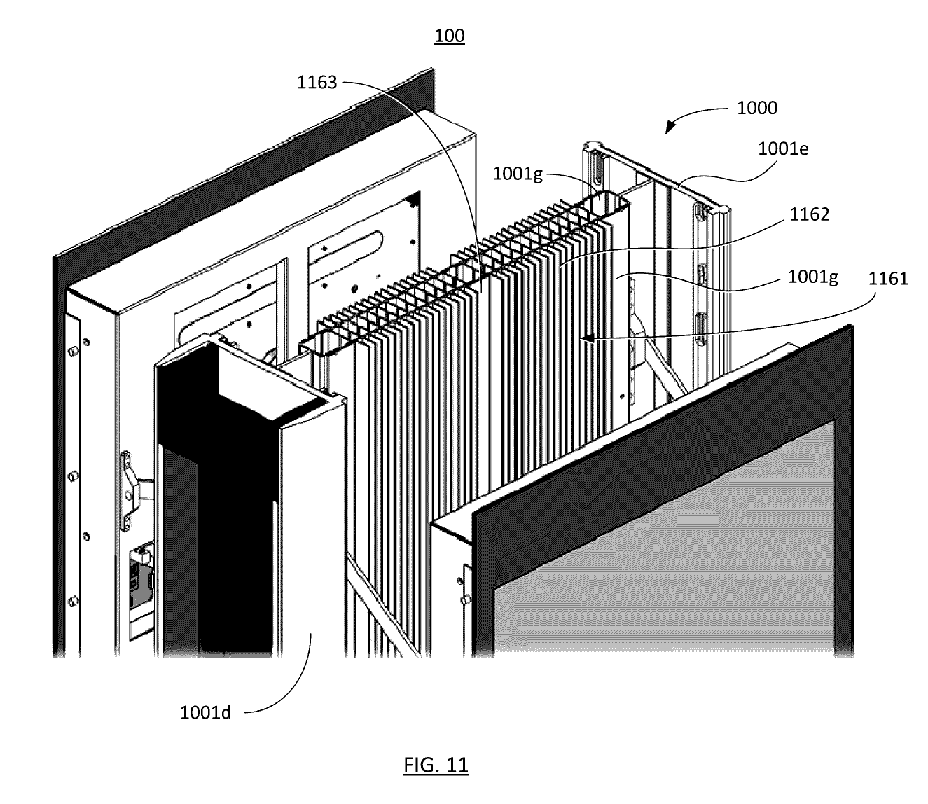

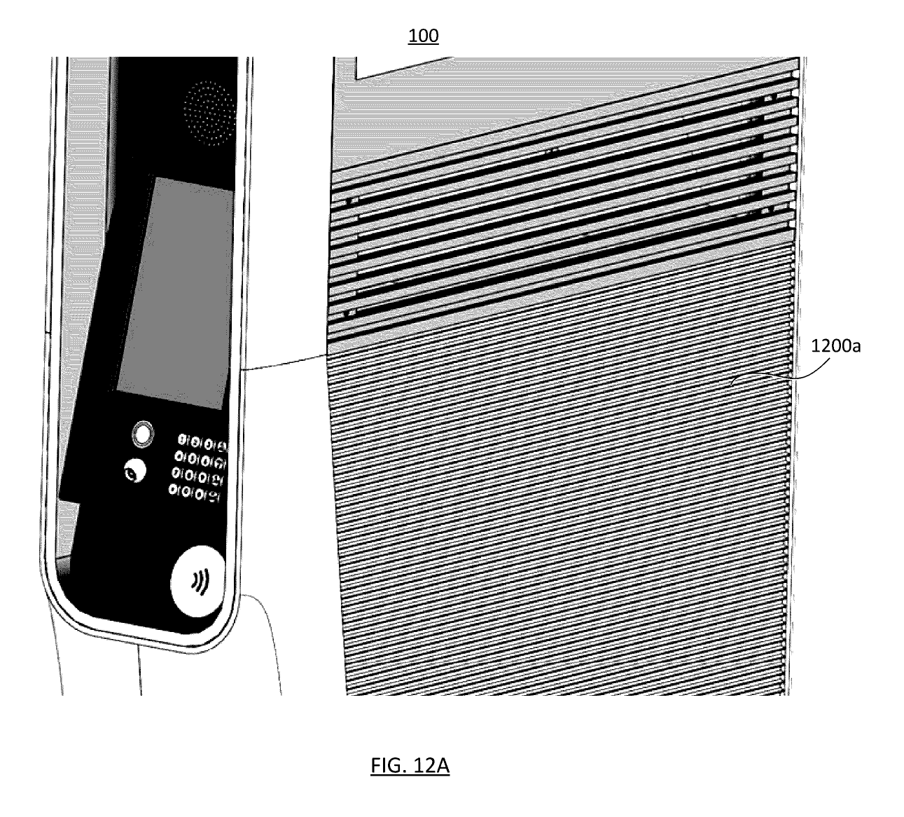

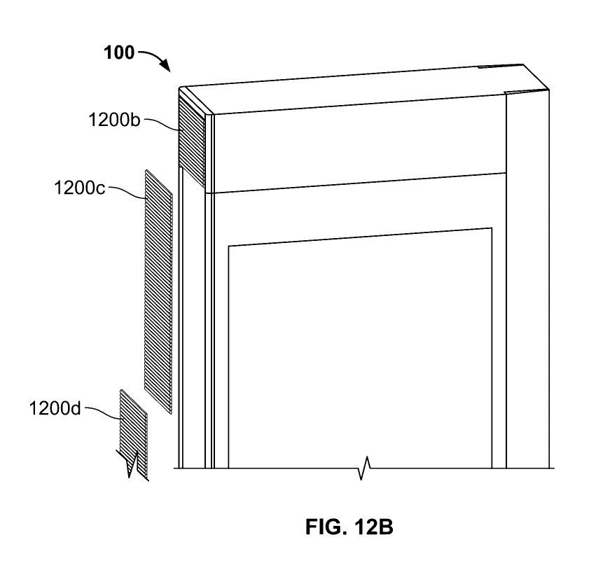

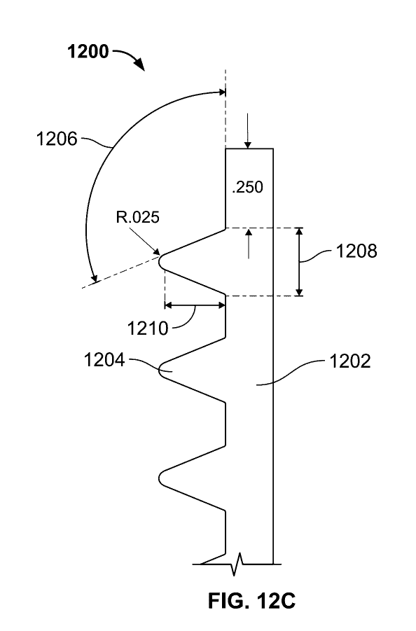

Referring to FIGS. 12A-12C, portions of a PCS's frame 1000 and/or compartments may be covered by ribbed panels 1200. The ribbed panels 1200 may discourage vandalism of PCS 100, since the panel ribs might offer a less appealing target for drawing, painting, or etching than other, smoother surfaces. In addition, the ribbed panels may be swappable, as shown in FIG. 12B, such that a damaged or vandalized panel could be quickly replaced with a pristine panel.

Referring to FIG. 12C, a ribbed panel 1200 may include a substantially planar member 1202 and a set of ribs 1204 extending from the planar member. In some embodiments, the angle 1206 between the outer surface of a rib and the outer surface of the planar member is between approximately 95° and 115°. In some embodiments, the thickness 1208 of a rib 1204 at the rib's base may be between approximately 0.25″ and 0.5″ and the width 1210 of a rib 1204 may be between approximately 0.3″ and 0.6″. Other dimensions may be used.

### Use of a Field Replaceable Unit (FRU) in a PCS

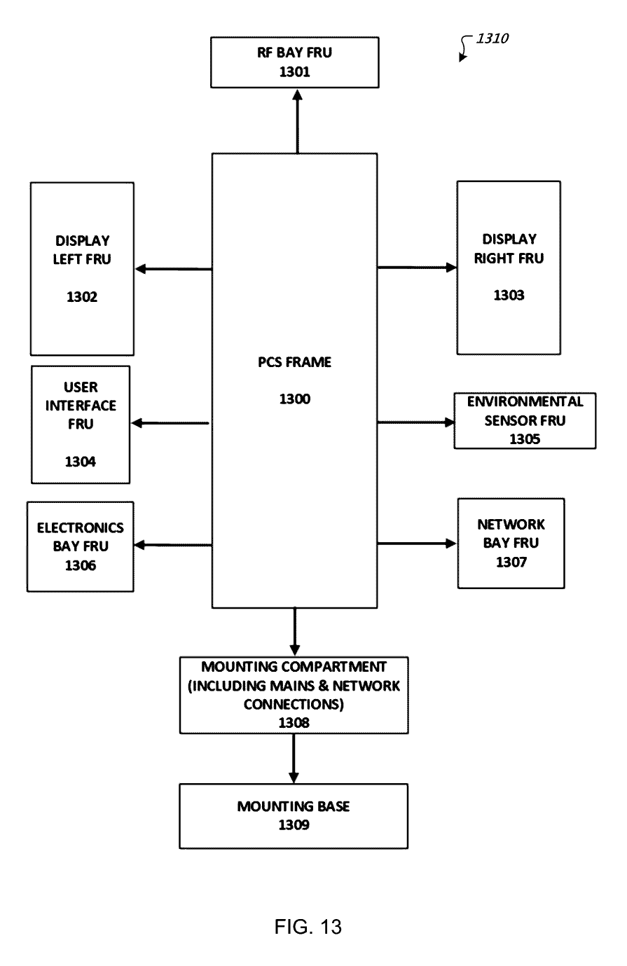

Referring to FIG. 13, in some embodiments, PCS 100 includes a field replaceable unit (FRU) system 1310 that allows the PCS 100 to be modularized into a frame and serviceable units that are readily field replaceable. An FRU may be or include, for example, a component, a set of components, a system, or a subsystem that can be replaced quickly and easily in the field when a fault occurs. An FRU preferably includes only a few mounting and electrical connections (e.g., one mounting connection and/or one electrical connection) for ease of removal and replacement. In general, because the PCS 100 is often located on city sidewalks or other areas with heavy pedestrian traffic, service personnel may not have the time or space to attempt complicated repairs of PCS 100 components, such as electronics parts or circuit boards. Use of repair tools in the field, such as soldering irons, is not desirable and may not be permitted. Field service personnel may also not be skilled technicians and may not be willing or able to troubleshoot problems associated with PCS 100. A preferred function of the field service personnel may therefore be to bring a replacement FRU to a specified PCS 100 location, gain access to a compartment that contains the faulty FRU, and remove and replace the FRU. Service personnel can then run a test to confirm good working order of the replacement FRU before the PCS 100 is placed back into service. In some embodiments, the PCS 100 can be field repaired down to a frame 1300.

Referring again to FIG. 9B, a height dimension 807 of the PCS 100 can be approximately 10 feet. This is primarily driven by U.S. FCC radio frequency (RF) exposure regulations requiring communications equipment to have a minimum separation distance of 20 cm (approximately 8 inches) from a bystander. Given that the bystander could be 8 feet tall or more, the PCS 100 communications compartment 880 is preferably located at least about 9 feet from a bottom of the PCS 100, to minimize exposure risks.

It is desirable that FRUs be serviceable or accessible without the use of ladders, scaffolding, etc. It is also preferable to be able to service PCS 100 without the use of heavy machinery (e.g., mechanical lifts, boom trucks, cranes, etc.), because such heavy machinery can present a safety hazard to pedestrians and/or take up street and sidewalk space. It can also be appreciated that ladders and machinery may require the area to be cordoned off and/or an on-duty police officer to be present to manage vehicular and pedestrian traffic. In a preferred embodiment, the FRUs contained in PCS 100 are serviceable from the street level by someone standing on the ground and may be removed and carried by hand. It can be appreciated that removing the entire PCS 100 structure and replacing it with a new one is generally not practical and should be avoided, unless the structure and/or frame 1000 of the PCS 100 become damaged, for example, due to a motor vehicle collision. In some applications, FRUs can be blade computers (e.g., server systems) that attach to backplanes and reside in indoor computer room environments. The PCS 100, however, generally resides in outdoor environments and may be subject to the elements, further requiring quick and easy access, removal and/or replacement of a faulty FRU. Examples of the subject matter described herein address problems associated with servicing a PCS structure that resides on a busy city sidewalk or in other public environments.

In the depicted embodiment, the FRU system 1310 includes an RF bay FRU 1301 (e.g., containing Wi-Fi, small cell, and/or antenna components), left and right display FRUs 1302 and 1303 (e.g., containing large displays for presenting advertisements on sides of the PCS 100), a user interface FRU 1304 (e.g., containing a small display and keypad for users to interact with the PCS 100), an environmental sensor FRU 1305 (e.g., containing sensors for monitoring the environment around the PCS 100), an electronics bay FRU 1306 (e.g., containing electronics, such as a power device, a processor, and a storage device), and a network bay FRU 1307 (e.g., containing networking equipment). The FRU system 1310 also includes a mounting compartment 1308 (e.g., for connecting the PCS 100 to a supply of electrical power and/or data networks) and a mounting base 1309 (e.g., for attaching the PCS 100 to a sidewalk or other public area).

In some embodiments, the frame 1300 is or includes a monocoque structure (e.g., similar to the frame 1000 in FIG. 10A). The frame 1300 may be a structural system that supports system components and forms or defines FRU compartments. In some examples, the frame 1300 is the same as or similar to the frame 1000. The frame 1300 preferably includes or accommodates an outer face of the user interface subsystem and/or a back side of the PCS 100. In some examples, outer skins of the PCS 100 are attached to the frame 1300. When an outer skin is damaged, the outer skin may be removed and replaced with a new outer skin. In general, frame 1300 should not require replacement unless the frame 1300 suffers significant damage and is no longer capable of supporting or containing the various PCS 100 system components. Such damage may occur when the PCS 100 is subjected to a large force, for example, during a motor vehicle collision. In some instances, if the frame 1300 of PCS 100 is compromised in any way, it may be more practical to replace the entire structure than to attempt a repair.

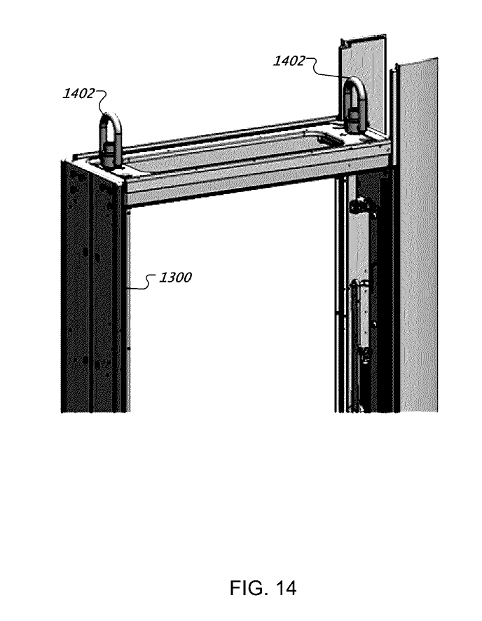

Referring to FIG. 14, in some embodiments, the PCS 100 includes hoist rings 1402 attached to a top portion of frame 1300. The hoist rings 1402 allow the frame 1300 to be picked up for installation or removal and/or carried away to a different location (e.g., using a service truck). For example, if the frame 1300 of the PCS 100 is damaged and requires replacement, service personnel may attach a crane to the hoist rings 1402 to lift the PCS 100 by the frame 1300 and place the PCS 100 onto a truck, which may transport the PCS 100 to a repair depot. The repair depot may remove all of the FRUs from the PCS 100 down to the frame 1300. The damaged FRUs may be repaired or disposed of, as desired. Undamaged FRUs may be tested and placed into repair inventory. The frame 1300 may be repaired or recycled and turned into new parts.

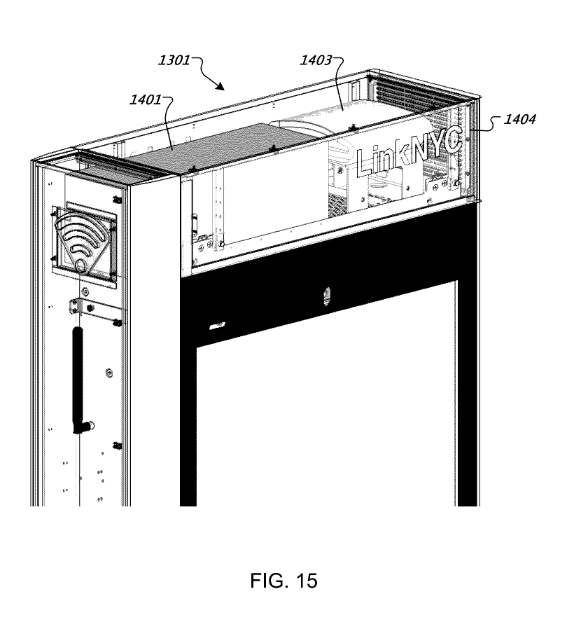

The RF bay FRU 1301 may include one or more Wi-Fi access points (e.g., wireless routers), one or more small cells, and/or one or more antennas (e.g., for connecting to cell phone towers). In high pedestrian traffic areas (e.g., near an athletic stadium or a downtown area of a large city), the RF bay FRU 1301 may include several Wi-Fi access points or small cell systems to accommodate a large volume of simultaneous users. FIG. 15 includes a perspective view of a PCS 100 in which an RF cover 1404 of the RF bay FRU 1301 is transparent, so internal components are visible. In the depicted embodiment, the RF bay FRU 1301 includes a Wi-Fi access point 1403, a small cell 1401, and an antenna. In some embodiments, RF bay FRU 1301 may include one or more brackets for mounting the Wi-Fi access point 1403 and/or the small cell 1401 within the RF bay FRU 1301. Once the RF bay FRU 1301 is unlocked from the PCS 100, the RF bay FRU 1301 assembly may be lifted off of the PCS 100. In one example, RF bay FRU 1301 may be unlocked from inside the PCS 100 using, for example, an electronic actuated lock. In some embodiments, the RF cover 1404, which may be the same as or similar to the cap 985, lifts or tilts up when unlocked to allow access to the RF bay FRU 1301. For example, once the RF cover 1404 is lifted up, the one or more mounting brackets may be unsecured (e.g., from a rail) and RF bay FRU 1301 may slide off to be removed.

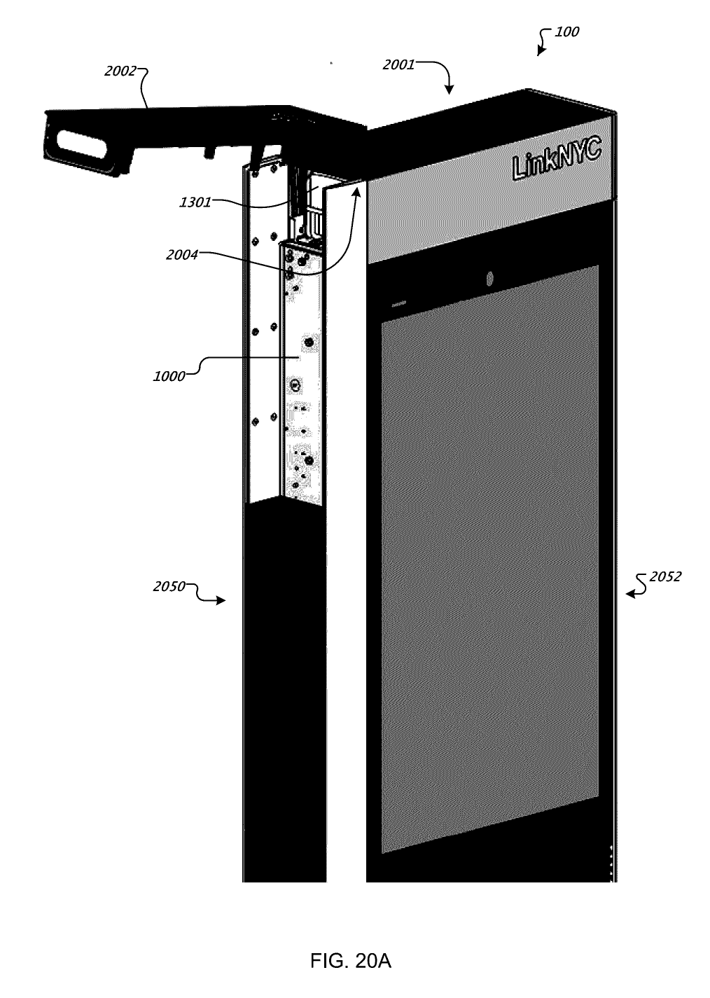

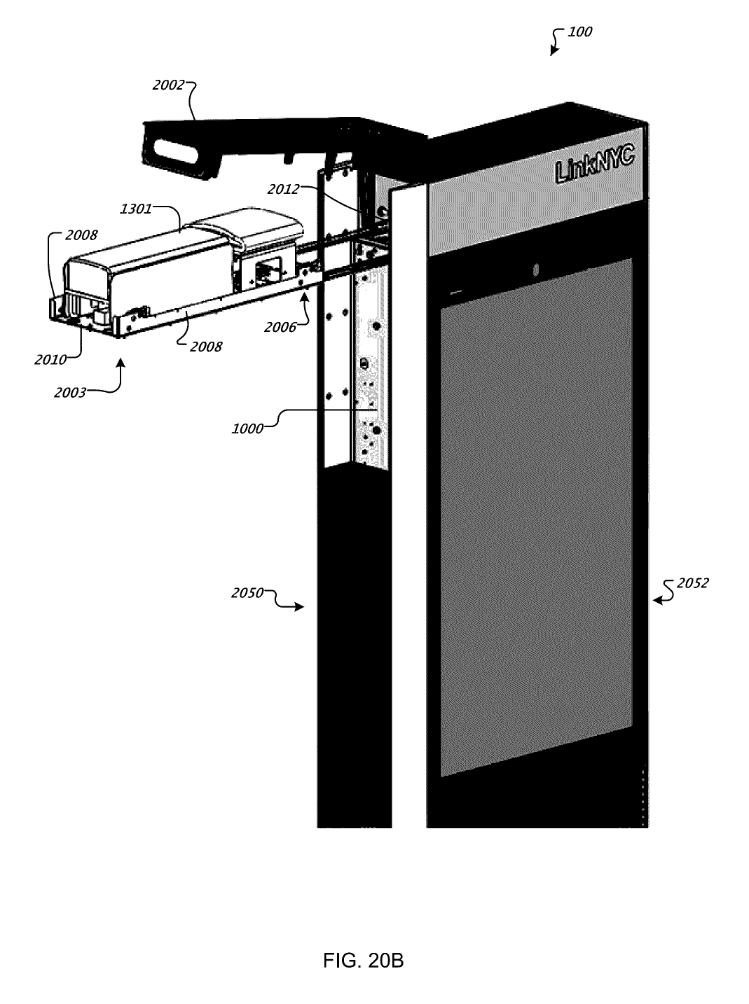

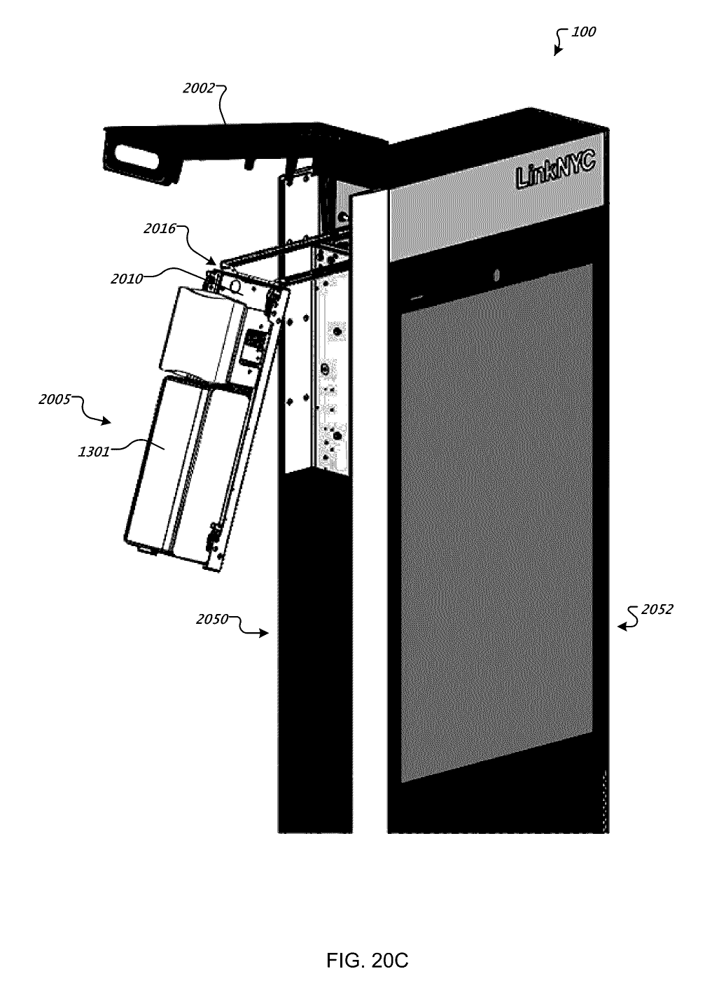

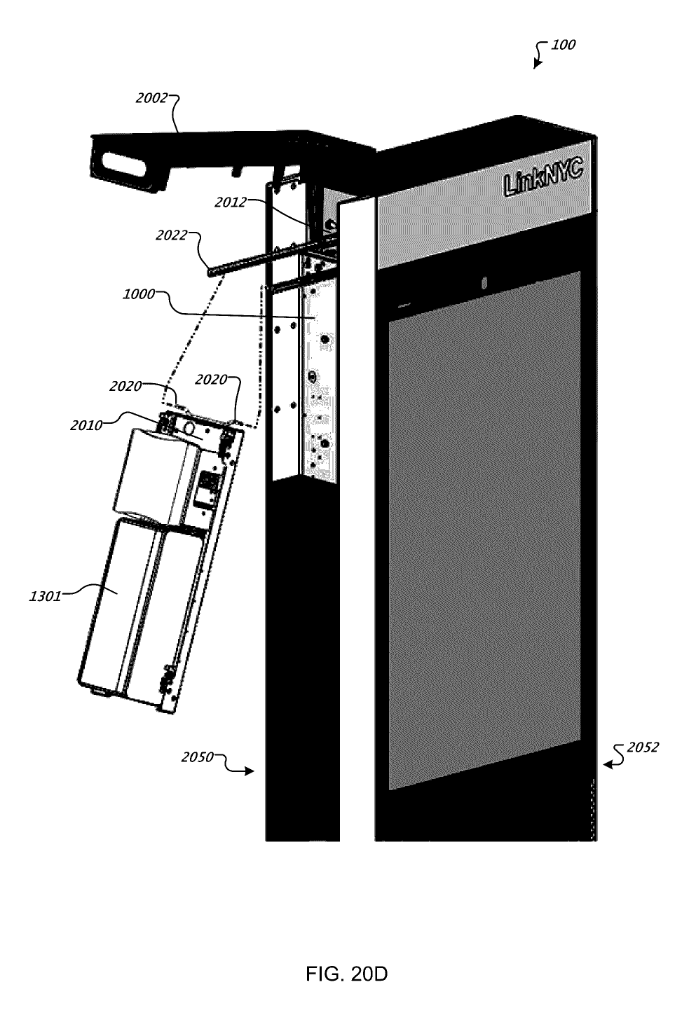

Referring to FIGS. 20A-20D, in one example, a front cover 2002 for the RF bay FRU 1301 may include a hinge 2004 that allows the front cover 2002 to rotate from a closed position to an open position. The opening and closing of the front cover 2002 may be motorized and/or driven by one or more springs, actuators, air cylinders, solenoids, or other pneumatic or mechanical devices. The front cover 2002 can be actuated by a repair person who presses one or more buttons on the tablet computing device 610 in User Interface FRU 1304. The service person can access a maintenance mode that includes the buttons, for example, by holding certain keys, pressing a maintenance application, and/or entering a password. Once the maintenance mode is accessed and the front cover 2002 is raised, the RF bay FRU 1301 is preferably exposed and can be removed and replaced.

In some embodiments, the RF bay FRU 1301 is supported by a rail system 2006 that allows the RF bay FRU 1301 to slide in a horizontal direction from an installed position 2001 on the frame 1000 to a second position 2003 outside the frame 1000. The rail system 2006 includes a pair of brackets 2008 on each side of a tray 2010 supporting the RF bay FRU 1301. The rail system 2006 also includes a corresponding pair of brackets 2012 attached to the frame 1000. The brackets 2008 attached to the tray 2010 are engaged with and configured to slide along the brackets 2012 attached to the frame 1000. To facilitate the sliding motion, at least one bearing (e.g., a roller) is disposed within the rail system 2006 (e.g., between the brackets 2008 and the brackets 2012).

As shown in FIG. 20C, the rail system 2006 preferably includes a hinge 2016 or pivot point that allows the tray 2010 to be angled downward into a service position 2005, so that the RF bay FRU 1301 can be removed or otherwise serviced by a person standing on the ground supporting the PCS 100 (e.g., without using a ladder). In a preferred implementation, the RF bay FRU 1301 has a quick release mechanism that allows simple disengagement of the RF bay FRU 1301 from the rail system 2006. Alternatively or additionally, the RF bay FRU 1301 can be removed from the tray 2010 with one or more screws, clamps, or latches. An example quick release mechanism includes a latch that allows a bracket to slide off the rail system 2006. An electrical cable connecting the RF bay FRU 1301 to the PCS 100 can be disconnected from the RF bay FRU 1301.

FIG. 20D shows an example release mechanism that includes two pins 2020 used for the hinge 2016. The pins 2020 are configured to be to be squeezed closer together to disengage the tray 2010 from the brackets 2012 attached to the frame 1000. The pins 2020 can include one or more springs that push the pins 2020 apart and into the proper position for maintaining the hinge 2016. Accordingly, to reattach the tray 2010 to the brackets 2012, the pins 2020 can be squeezed together and aligned with one or more knuckles 2022 on the hinge 2016. Once the pins 2020 are in proper alignment, the pins 2020 can be released into the knuckles 2022, using the spring, to form the hinge 2016.

In some examples, the rail system 2006 includes a pair of intermediate rails positioned between the brackets 2008 and the brackets 2012. The intermediate rails may include or utilize one or more bearings and may slide along and/or between the brackets 2008 and the brackets 2012, on each side of the tray 2010. For example, when the brackets 2008 attached to the tray 2010 slide from the installed position 2001 to the second position 2003, the intermediate rail may slide approximately half the distance traveled by the brackets 2008. An end of the intermediate rails may include the knuckles 2022 for the hinge 2016. The intermediate rails may remain engaged and aligned with the brackets 2012 attached to the frame 2012.

Once detached from the PCS 100, the RF bay FRU 1301 can be hand carried and replaced with a new RF bay FRU 1301. In one example, the new RF bay FRU 1301 is slid onto the rail system 2006 and/or reattached to the brackets 2012 (e.g., at the hinge 2016). The RF bay FRU 1301 can then be then lifted and slid back into the installed position 2001 (e.g., the communications compartment 880), as shown in FIG. 20A. The service person can use a special cane or other tool to lift and/or slide the RF bay FRU 1301 back into the installed position 2001. In one embodiment, the service person uses a cane that hooks onto the tray 2010 and/or a component of the RF bay FRU 1301, so that the service person can manipulate the RF bay FRU 1301 into or out of the installed position 2001. The cane can allow the service person to support the RF bay FRU 1301 when it is slid from the installed position 2001. Such support can prevent the RF bay FRU 1301 from swinging downward (e.g., from the hinge 2016) and causing damage to the RF bay FRU 1301 or other PCS 100 components.

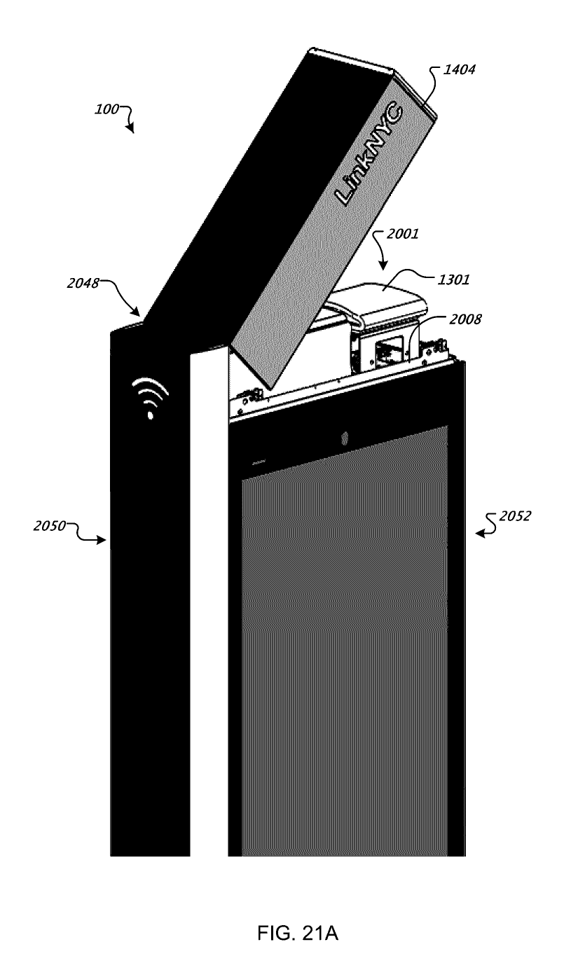

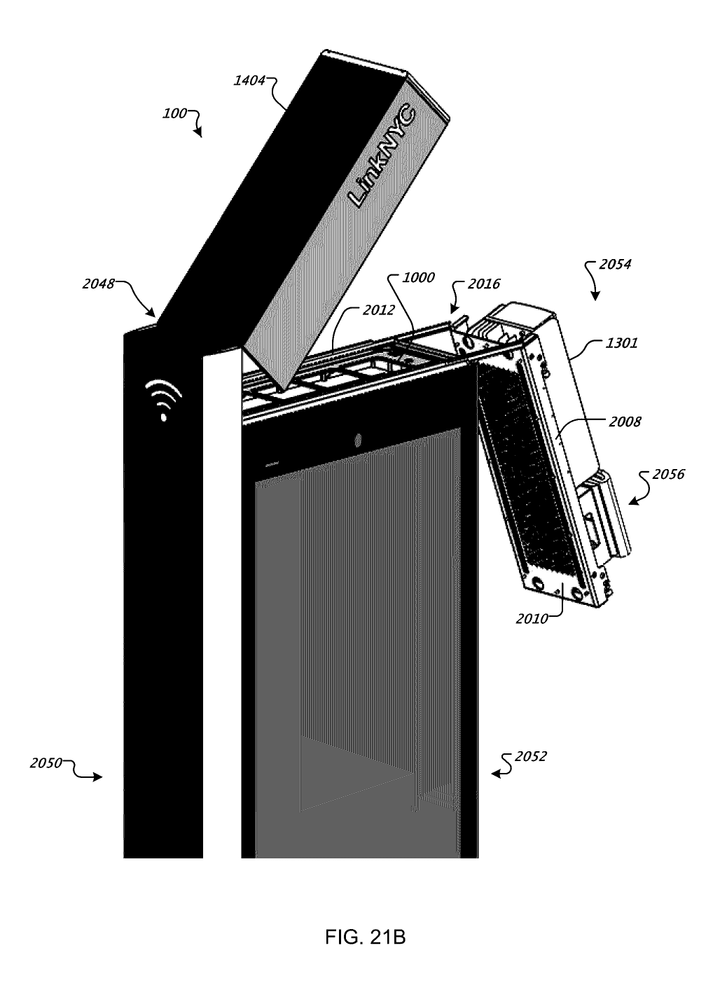

While FIGS. 20A-20D show the service position 2005 being located at a front side 2050 of the PCS 100, a service position can alternatively be located at a back side 2052 of the PCS 100, as shown in FIGS. 21A and 21B. In that case, the RF cover 1404 can be opened using a hinge 2048, and the same or similar equipment (e.g., the rail system 2006, the brackets 2008 and 2012, and/or the hinge 2016) can be used to slide the RF bay FRU 1301 in a horizontal location from the installed position 2001 on the frame 1000 to a second position 2054 outside the frame 1000. The RF bay FRU 1301 can then be tilted downward into a service position 2056, where a service person can replace the RF bay FRU 1301 with a new RF bay FRU 1301. The service person can then move the RF bay FRU 1301 from the service position 2056 at the back side 2052 of the PCS 100 to the installed position 2001 on the frame 1000.

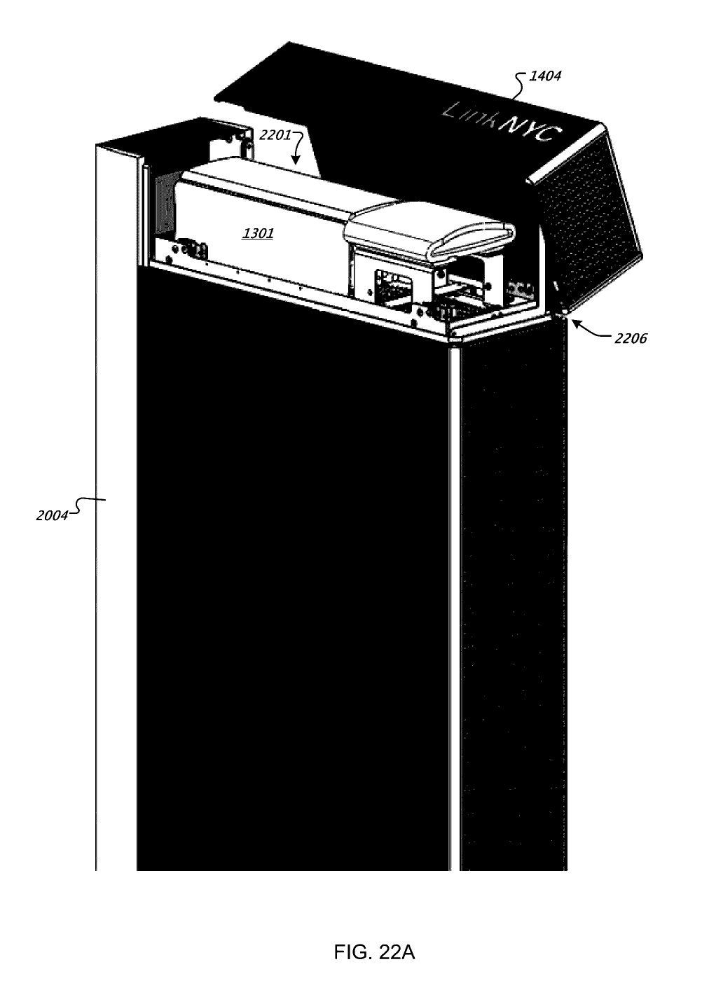

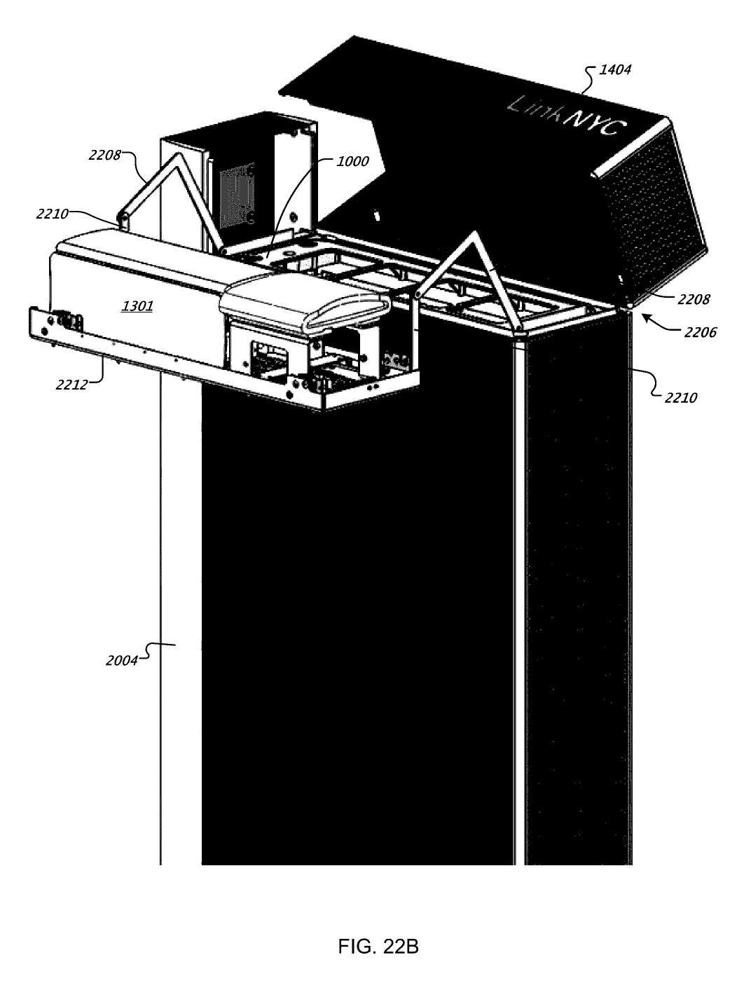

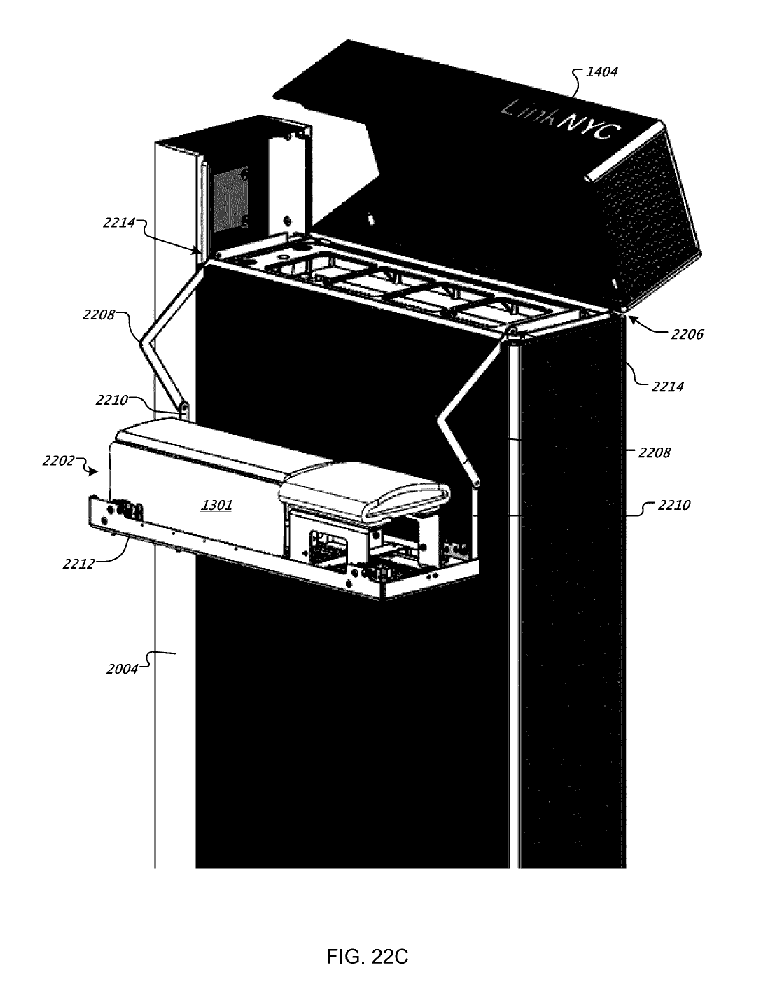

FIGS. 22A-22C are schematic, perspective views illustrating a mechanism for moving the RF bay FRU 1301 from an installed position 2201 on the frame 1000 to a service position 2202 at a side 2204 of the frame 1000. As depicted, the RF cover 1404 can include a hinge 2206 that allows the RF cover 1404 to rotate into an open position (e.g., using a motor or other actuator). The mechanism for moving the RF bay FRU 1301 includes two articulated lifting brackets 2208 or arms pivotably connected to back and front portions of the frame 1000. The lifting brackets 2208 are pivotably connected to a pair of hanging members 2210 attached to a tray 2212 supporting the RF bay 1301. To lift the RF bay FRU 1301 from the installed position 2201, a motor or other actuator rotates the lifting brackets 2208 up and away from a top of the frame 1000 about a pivot point 2214, which may include a pin. This causes the RF bay FRU 1301 to be lifted from the installed position 2201 and lowered down to the service position 2202. With the RF bay FRU 1301 in the service position 2202, a service person can access the RF bay FRU 1301 (e.g., preferably without using a ladder). For example, the service person can remove the RF bay FRU 1301 from the tray 2212 and install a new RF bay FRU 1301 (e.g., using one or more screws, clamps, or latches). With the new RF bay FRU 1301 installed, the lifting brackets 2208 can be rotated in an opposite direction about the pivot point 2214, to move the new RF bay FRU 1301 into the installed position 2201. The lifting brackets 2208 are depicted as being L-shaped; however, other shapes (e.g., C-shaped) for the lifting brackets 2208 are contemplated.

In preferred examples, the tray 2212 is maintained at a level orientation (e.g., with respect to horizontal) during travel between the installed position 2201 and the service position 2202. The level orientation can be achieved with proper gearing at pivot locations, for example, to ensure any rotation of the lifting brackets 2208 results in no rotation of the hanging members 2210 and/or the tray 2212. In one example, the hanging members 2210 are attached to the tray 2212 at a location beneath a center of mass of the RF bay FRU 1301. Such positioning can prevent the tray 2212 from tilting toward or away from the PCS 100, due to imbalance. Alternatively, each end of the tray 2212 can include two hanging members 2210, with each hanging member 2210 attached to a corner of the tray 2212. Use of additional hanging members 2010 may further stabilize the tray 2212.

In a preferred embodiment, the RF cover 1404 can be replaced by using a release mechanism (e.g., located at the hinge 2048 or the hinge 2206). It can be appreciated that the RF cover 1404 may be made out of polycarbonate, acrylic, or similar RF permeable material, so that small cell 1401 and WiFi 1403 signals sent or received by RF bay FRU 1301 are not attenuated. The RF cover 1404 is preferably resistant to the elements (e.g., UV radiation, water, ice, snow, etc.), however, it is recognized that the RF cover 1404 may deteriorate over time, such that the RF cover 1404 can be replaced using the release mechanism.

In some embodiments, the mechanisms used to open the RF cover 1404, open the front cover 2002, and/or move the RF bay FRU 1301 to and from the service locations may be automated. For example, a service person may press a button that automatically unlocks (using a solenoid, etc.) and opens the RF cover 1404 and/or the front cover 2002. Additionally or alternatively, the RF bay FRU 1301 can be moved from an installed position to a service position using, for example, a motor with a drive gear, a motorized pulley system, a solenoid, an air cylinder, or other mechanical devices. Counterbalances can be used to reduce the load required to move covers and/or the RF bay FRU 1301. Once in the service position, the service person can replace the RF bay FRU 1301 and then press a button to return the RF bay FRU 1301 to the installed position and/or close any open covers. In some examples, the RF cover 1404 and/or the front cover 2002 include a lock that is electronically activated, for example, using a solenoid to slide a member into a locked position.

In various examples, the RF bay FRU 1301 is connected to the PCS 100 using an electrical harness. The electrical harness can include a a service loop that allows the RF bay FRU 1301 to be electrically disconnected when the RF bay FRU 1301 is in the service position. In some embodiments, there a single electrical harness is used, so that the RF bay FRU 1301 can be detached quickly and easily (e.g., using a threaded, clipped, or other connection). In some embodiments, each component on the RF bay FRU 1301 (e.g., the WiFi access point, the small cell, or the antenna) has its own connection. It can be appreciated that the RF bay FRU 1301 may use power over Ethernet (PoE) or similar techniques to limit the number of cables and connections required. In certain applications, the RF bay FRU 1301 is or includes the communications compartment 880, the radio access node 981, the wireless access point 983, and/or one or more antennas.

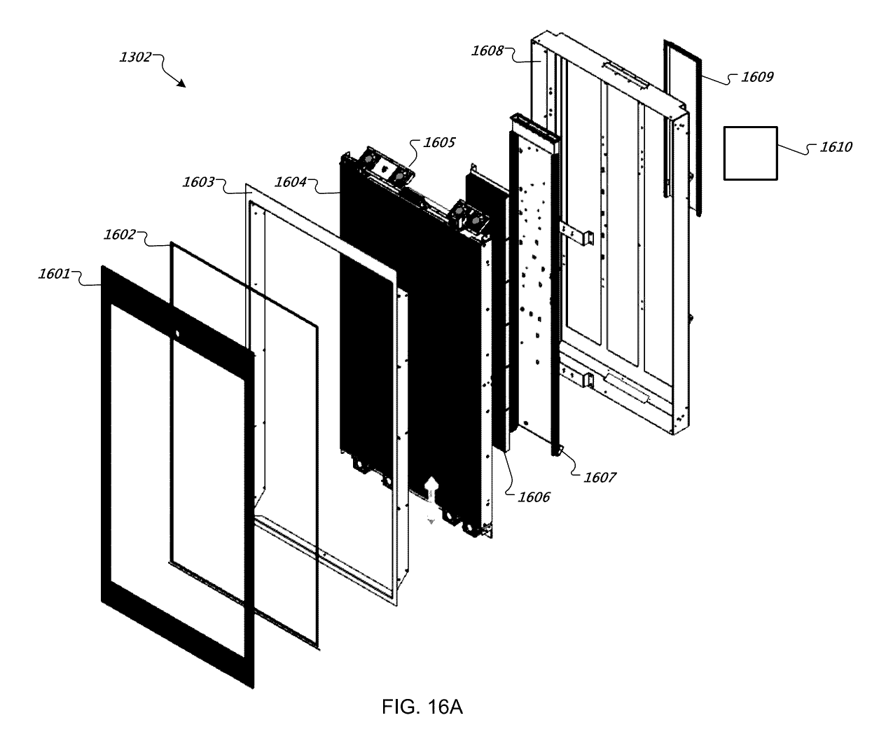

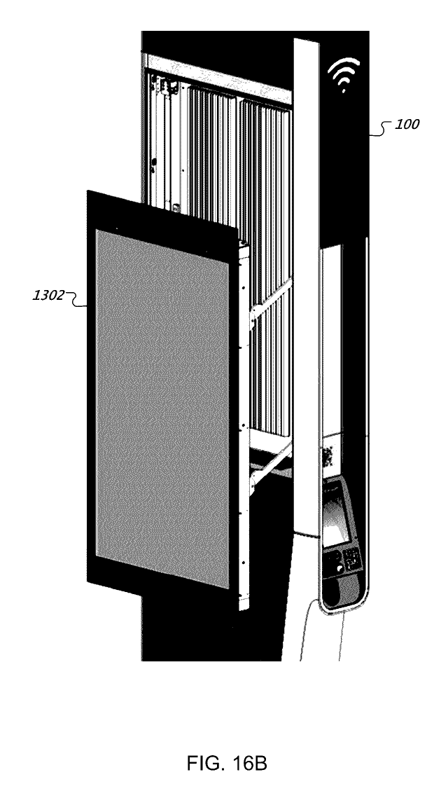

FIGS. 16A and 16B show an exploded view and a perspective view, respectively, of the left display FRU 1302, in accordance with certain embodiments. The left display FRU 1302 and the right display FRU 1303 (as shown in FIG. 13) are located on upper sides of PCS 100, and may be used to present large images or advertisements, for example. In a preferred embodiment, the left and right display FRUs 1302 and 1303 are identical. It can be appreciated that it is easier for a service person to carry one replacement display FRU that can fit in both the right and left displays in display compartment 870. In other embodiments the left and right display FRUs 1302 and 1303 may instead be mirror images of one another. The left display FRU 1302 may include a display panel 1604, protective glass 1601, gasket 1602, front frame 1603, cooling fans 1605, heat sink 1606, air channel 1607, rear frame 1608, controller mount 1609, and a controller 1610. Protective glass 1601 may be strengthened (e.g., chemically) and preferably is able to withstand substantial impact forces (e.g., due to normal wear and tear or extreme weather conditions, such as hail or high winds). Gasket 1602 seals the protective glass 1601 to front frame 1603. Cooling fans 1605, heat sink 1606, and an air channel 1607 keep the display FRU 1302 cool by circulating air within the display FRU 1302. The display FRUs 1302 and 1303 periodically may be damaged (e.g., due to vandalism) and may require replacement. As depicted in FIG. 16B, the display FRU 1302 may be opened and lowered to a service position, in which the display FRU 1302 may be readily removed (e.g., with screws or clips) and replaced with a new unit.

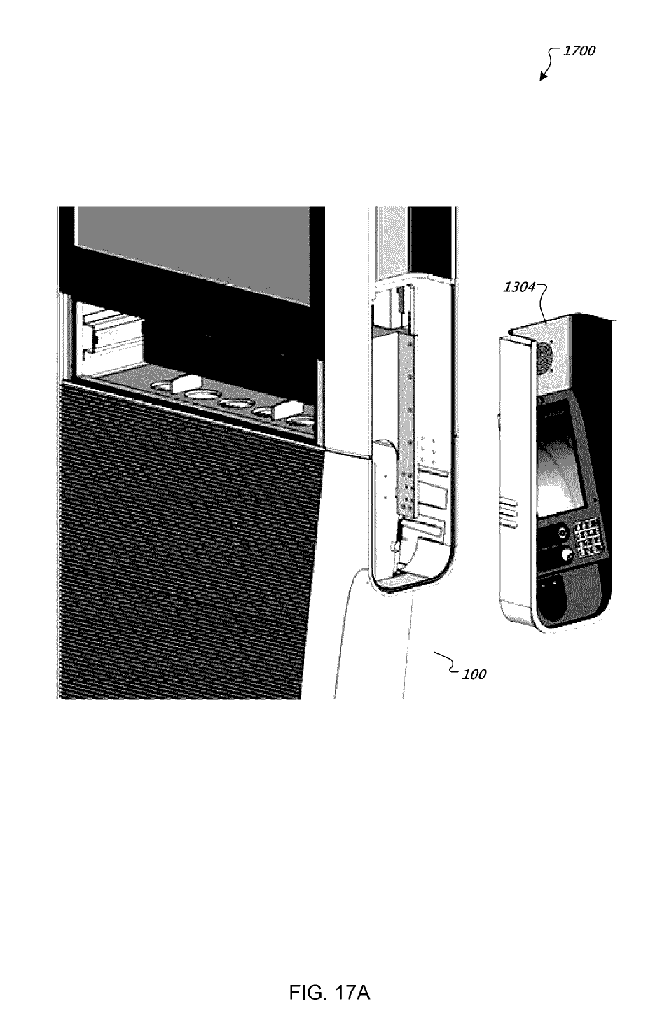

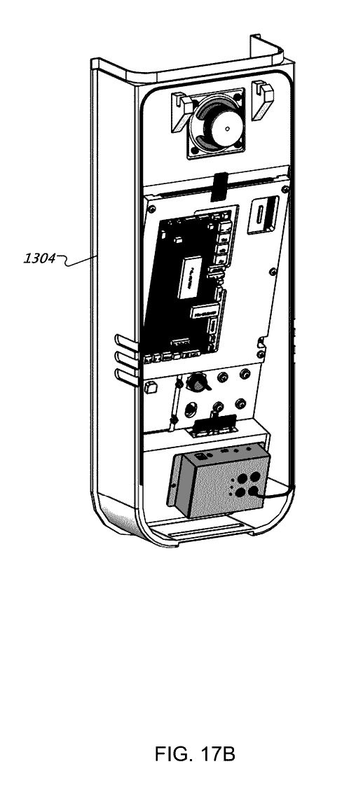

User interface FRU 1304 is shown removed from PCS 100 in FIG. 17A. In some embodiments, the user interface FRU 1304 is removed from a front side of PCS 100 (e.g., with mounts internal to PCS 100 being located at the rear of the user interface FRU 1304). It can be appreciated that removing the user interface FRU 1304 from the front side facilitates the removal and replacement of the FRU 1304. Removal from the front can also provide a tight seal around edges of the user interface FRU 1304 that make it difficult for a vandal to attempt to pry open the FRU 1304 (e.g., using a tool such as a screw driver or crowbar). The tight seal also prevents ingress of water and/or other environmental material, given that FRU 1304 can be oriented at an angle and/or exposed to outdoor elements (e.g., rain, sleet, hail, or snow). Mounts for the user interface FRU 1304 are preferably accessed by removing a side air intake panel. A rear side of user interface FRU 1304 is shown in FIG. 17B. Mounting from the rear can also prevent unauthorized removal of the user interface FRU 1304 because such mounting can avoid the use of external screws or clips that can be accessed from the outside. In some embodiments, user interface FRU 1304 may be the same as or substantially similar to the user interface subsystem 150 described above and shown in FIG. 6. In some instances, one or more components of the user interface FRU 1304 may suffer damage (e.g., due to vandalism or normal wear and tear) and/or stop working and may require replacement. For example, USB charger port 620 and/or headset jack 602 may see a lot of use daily, in addition to being exposed to the outside elements. Likewise, a display and/or keypad on the user interface FRU 1304 may breakdown or be damaged. When one or more components of the user interface FRU 1304 is no longer working properly, the entire user interface FRU 1304 may be removed (e.g., with screws or clips) and replaced with a new unit. The removed user interface FRU 1304 may be refurbished with one or more new components and/or otherwise recycled for subsequent reuse.

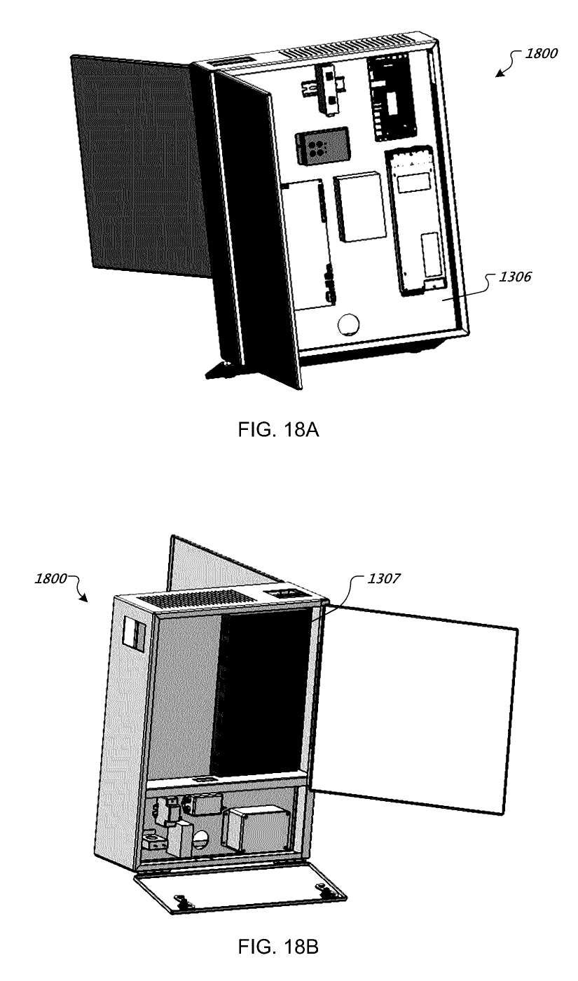

FIGS. 18A and 18B show an example system 1800 in which the electronics bay FRU 1306 and the network bay FRU 1307 are arranged back-to-back in a single enclosure having separate access panels. The access panels may allow the electronics bay FRU 1306 and/or the network bay FRU 1307, or one or more components thereof, to be serviced or replaced, as needed. In other instances, the entire system 1800 be removed and brought to a repair depot. In alternative embodiments, the electronics bay FRU 1306 and the network bay FRU 1307 may each be contained within a separate enclosure, which may be removed and/or serviced separately, as required. The electronics bay FRU 1306 may contain one or more power supplies, fans, circuit breakers, surge suppressors, line filters, ground fault interrupters, power distribution boards, maintenance controllers, relays, PoE injectors, door switches and/or any other type of electronic components understood by those skilled in the art. The network bay FRU 1307 may contain one or more network service switches, Ethernet switches, PoE injectors, door switches and/or any other type of network components understood by those skilled in the art. As described above, the electronics bay FRU 1306 and the network bay FRU 1307 may include a considerable amount of electronics and may be subjected to extreme temperatures during warm summer days. The enclosures and systems components are designed to permit easy replacement of the electronics bay FRU 1306 and the network bay FRU 1307.

In preferred embodiments, each FRU described herein is designed to be connected to the PCS 100 using only one electrical cable that preferably uses a quick disconnect mechanism. By limiting the number of electrical cables, the job of removing and replacing an FRU is simplified. Quick disconnect mechanisms can make this FRU replacement task even easier. An example quick disconnect mechanism includes a latching connector that a service person can actuate to disengage the connector. In certain embodiments, the electronics bay FRU 1306 and network bay FRU 1307 are configured to limit the number of mounting connections, thereby facilitating removal and/or installation.

In some embodiments, PCS 100 attaches to the mounting base 1309 via connections in the mounting compartment 1308. The mounting compartment 1308 preferably includes connections to main power and one or more networks. These connections may include or utilize, for example, fiber optics and/or copper wire.

The environmental sensor FRU 1305 may be mounted behind the air intake panel 967 (shown in FIG. 9C) of the PCS 100. It can be appreciated that sensors within the environmental sensor FRU 1305 should be as close to incoming air as possible, so any measurements taken are indicative of outside ambient air conditions. Environmental sensor FRU 1305 may include or utilize one or more sensors for measuring or detecting oxygen, carbon dioxide, carbon monoxide, nitrogen dioxide, ozone, pollution, particulate matter, smoke, gasoline, sulfur dioxide, hydrogen chloride, hydrogen cyanide, ammonia, methane, poison, poisonous gas, insecticide, chlorofluorocarbons, volatile organics, lead, radiation, temperature, humidity, pressure, sound, acceleration, velocity, motion, vibration and/or seismic activity. In some embodiments, environmental sensor FRU 1305 has a single electrical connection (e.g., a mini-USB, micro-USB or PoE RJ45 connection). In some embodiments, the environmental sensor FRU 1305 is mounted to a back side of the air intake panel 967. To access the environmental sensor FRU 1305, the air intake panel 967 may be opened or removed. In some examples, the PCS 100 has an air intake panel FRU that includes the air intake panel 967, the environmental sensor FRU 1305, and optionally an air filter. All of these components may be replaced by removing the air intake panel FRU and installing a new replacement unit. In some instances, the environmental sensor FRU 1305 is removed or opened to service, clean, or replace one or more sensors within the environmental sensor FRU 1305. Some sensors may have limited life expectancy, so ease of replacement is desired. In some embodiments, FRUs that are removed from the PCS 100 can be brought to a service center for cleaning and/or repair.

In some embodiments, it is required or desirable to have an FRU with an access panel that is easy to unlock and/or remove. Alternatively or additionally, it may be desired or required to have a limited number of electrical connections (e.g., no more than six or no more than four) and/or mechanical or mounting connections (e.g., no more than four or no more than two) for an FRU. Fewer electrical connections and/or mechanical connections make it easier to remove or replace the FRU. Preferably, any electrical or mechanical connectors used for the FRU can be unplugged quickly. Any skins, access panels, cable harnesses, mounting hardware or other hardware associated with the FRU are preferably easy to remove and replace.

In some embodiments, maintenance providers for the PCS 100 may be contractually obligated to replace any faulty PCS 100 components or FRUs within a specified period of time (e.g., within 24 hours). Also, given that there may be several thousand PCS 100 locations that are operational at the same time, the FRU replacement process should be streamlined. Service personnel may be required to service many (e.g., 10 or 100 or more) PCS 100 locations in a 24 hour period.

In various implementations, systems and methods are provided for performing diagnostic self-testing in a PCS 100. It is important to be able to accurately detect faults and to transmit diagnostic test results and any associated codes (e.g., containing information about a faulty PCS 100 component or FRU) to a remote service center, along with location and other relevant information for the PCS 100, to streamline the field service response. In some embodiments, the FRU has an associated stock keeping unit (SKU) number. For example, when self-test results identify a faulty FRU, a controller in the PCS 100 may transmit the associated SKU number to the service center, so a replacement unit can be identified and retrieved from inventory. Preferably, the fault communication and replacement part identification process is automated, to facilitate the servicing of many PCS 100 locations in a single day.

In certain examples, techniques and apparatus are provided for mounting a housing on a PCS. It can be appreciated that timely field service of faulty display FRUs 1302 and 1303 is important because the display FRUs 1302 and 1303 generate advertisement revenue. In addition, the use of ladders on city streets may be prohibited and the display FRUs 1302 and 1303 may be large and heavy. The display FRUs 1302 and 1303 can preferably be lowered from a closed position to an opened service position, as in FIG. 16B. This allows the display FRUs 1302 and 1303 to be removed and hand carried to a truck, without the use of a ladder. In general, it is advantageous to have service personnel remove an FRU while standing on the ground, rather than while standing on a ladder or scaffolding, which can present a safety hazard to the service personnel or the general public. The display FRUs 1302 and 1303 may be subjected to excessive temperatures during the summer months, when the display brightness may need to be increased to overcome high ambient light conditions. Such high brightness conditions may increase the temperature of the display FRUs 1302 and 1303, thereby increasing the probability of field failures. Damage may also occur to due vandalism and/or normal wear and tear. If the protective glass 1601 of the display FRUs 1302 and 1303 becomes broken or damaged, the PCS 100 may become a public safety hazard. It is therefore important to streamline the process for replacing the display FRUs 1302 and 1303 when damage or faults occur.

In some embodiments, techniques and apparatus are provided for controlling access to components of a PCS 100. It can be appreciated that independently controlling access to the FRU compartments can avoid unauthorized access or theft. Access to each FRU may require a certain key or code. For example, a specific key or code may be used to access the RF bay FRU 1301, but that key or code may not provide access to any other FRUs or internal components of the PCS 100. In one example, a field service person may be authorized to replace the RF bay FRU 1301 but not authorized to work on the mounting compartment 1308, which has power connections and may require a licensed electrician for service. In that case, the key or code used by the field service person preferably grants access to the RF bay FRU 1301 but does not grant access to the mounting compartment 1308.

In certain implementations, a service center may control access to a compartment on a PCS 100. For example, if the PCS 100 is scheduled for service of a specific FRU, the service center may grant access to that compartment when field service personnel are onsite at the PCS 100 location. Access to the compartment may be granted remotely by the service center, for example, by transmitting a signal from the service center to the PCS 100. Service personnel may then open the compartment (e.g., with the use of a key or other authentication data) to access or service the FRU. Service personnel can then test the FRU using a maintenance mode or certain diagnostic testing (e.g., a self-test).

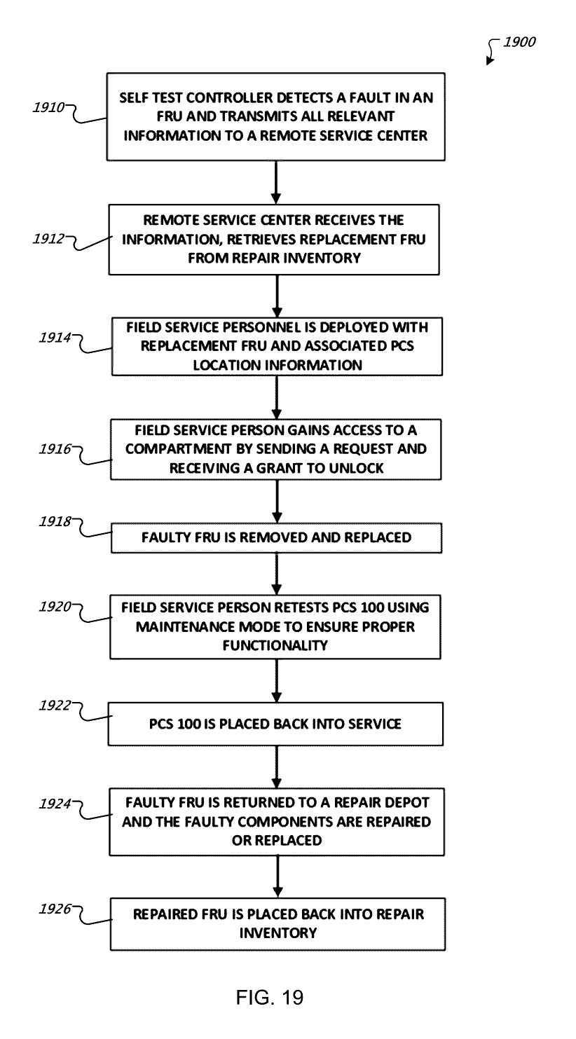

FIG. 19 is a flowchart of an example method 1900 for replacing FRUs in a PCS 100. The method 1900 includes detecting (step 1910) a fault in an FRU and retrieving (step 1912) a replacement FRU from inventory. The method also includes deploying (step 1914) service personnel who then gain access (step 1916) to the PCS 100. The faulty FRU is removed and replaced (step 1918), and the replacement is tested (step 1920) for proper functioning. The PCS 100 may then be placed back into service (step 1922). Preferably, the faulty FRU is returned (step 1924) to a repair depot where it may be repaired and placed back into inventory (step 1926). The method 1900 may be used and/or repeated for any or all of the PCS 100 locations in service. In some examples, service personnel are deployed with replacement FRUs for multiple PCS 100 locations, so that more than one PCS 100 can be repaired in a single deployment from the service center. Optimal service routes can be determined by calculating shortest routes between PCS 100 locations that require service.

In some embodiments, the FRUs described herein may be field replaced when newer technology or advanced designs become available. For example, Wi-Fi access point technology continues to be developed to allow for faster data speeds and an increasing number of users. In some examples, a speed of the Wi-Fi access point(s) in the RF bay FRU 1301 is about one GB/sec or higher. It can be appreciated that when a 10 GB/sec Wi-Fi access point becomes available, it would be desirable to do a technology refresh by replacing the existing RF bay FRU 1301 with the new, faster unit. The removed RF bay FRU 1301 can then be sent to a service center to have the Wi-Fi access point upgraded and may then be re-deployed into another PCS 100 that needs upgrading. It can be appreciated that the self-test step in FIG. 19 could be replaced with a list of PCS 100 locations to upgrade.

### Further Description of Some Embodiments

The various methods or processes outlined herein can be coded as software that is executable on one or more processors that employ one of a variety of operating systems or platforms. Additionally, such software can be written using any of a number of suitable programming languages and/or programming or scripting tools, and also can be compiled as executable machine language code or intermediate code that is executed on a framework or virtual machine. Also, the acts performed as part of the techniques described herein can be performed in any suitable order.

In this respect, the methods described herein can be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various techniques discussed above. The computer readable medium or media can be non-transitory. The computer readable medium or media can be transportable, such that the program or programs stored thereon can be loaded onto one or more different computers or other processors to implement various aspects of the present invention as discussed above. The terms “program” or “software” are used herein in a generic sense to refer to computer code or set of computer-executable instructions that can be employed to program a computer or other processor to implement various aspects described in the present disclosure. Additionally, it should be appreciated that according to one aspect of this disclosure, one or more computer programs that when executed perform techniques described herein need not reside on a single computer or processor, but can be distributed in a modular fashion amongst a number of different computers or processors to implement various aspects of the present invention.

Computer-executable instructions can be in many forms, such as program modules, executed by one or more computers or other devices. Generally, program modules include routines, programs, objects, components, data structures, etc. that perform particular tasks or implement particular abstract data types. Typically the functionality of the program modules can be combined or distributed as desired in various embodiments.

Also, data structures can be stored in computer-readable media in any suitable form. For simplicity of illustration, data structures can be shown to have fields that are related through location in the data structure. Such relationships can likewise be achieved by assigning storage for the fields with locations in a computer-readable medium that conveys relationship between the fields. However, any suitable mechanism can be used to establish a relationship between information in fields of a data structure, including through the use of pointers, tags or other mechanisms that establish a relationship between data elements.

In some embodiments the technique(s) can be implemented as computer instructions stored in portions of a computer's random access memory to provide control logic that affects the processes described above. In such an embodiment, the program can be written in any one of a number of high-level languages, such as FORTRAN, PASCAL, C, C++, C#, Java, JavaScript, Tcl, or BASIC. Further, the program can be written in a script, macro, or functionality embedded in commercially available software, such as EXCEL or VISUAL BASIC. Additionally, the software can be implemented in an assembly language directed to a microprocessor resident on a computer. For example, the software can be implemented in Intel 80×86 assembly language if it is configured to run on an IBM PC or PC clone. The software can be embedded on an article of manufacture including, but not limited to, “computer-readable program means” such as a floppy disk, a hard disk, an optical disk, a magnetic tape, a PROM, an EPROM, or CD-ROM.

Embodiments have been described in which various aspects of the techniques described herein are applied to a personal communication structure (PCS). In some embodiments, aspects of the techniques described herein may be applied to any suitable structure including, without limitation, a kiosk (e.g., an interactive kiosk), pay station (e.g., parking pay station), automated teller machine (ATM), article of street furniture (e.g., mailbox, bench, traffic barrier, bollard, telephone booth, streetlamp, traffic signal, traffic sign, public transit sign, public transit shelter, taxi stand, public lavatory, fountain, watering trough, memorial, sculpture, waste receptacle, fire hydrant, vending machine, utility pole, etc.), etc.

Various aspects of the present disclosure can be used alone, in combination, or in a variety of arrangements not specifically described in the foregoing, and the invention is therefore not limited in its application to the details and arrangement of components set forth in the foregoing description or illustrated in the drawings. For example, aspects described in one embodiment can be combined in a suitable manner with aspects described in other embodiments.

### TERMINOLOGY

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

### EQUIVALENTS

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A personal communication structure comprising:
a frame;
a field replaceable unit; and
a mechanism for moving the field replaceable unit from an installed position disposed on the frame to a service position disposed outside the frame, the mechanism comprising:
at least one bearing for sliding the field replaceable unit in a horizontal direction from the installed position to a second position outside the frame; and
at least one hinge for tilting the field replaceable unit from the second position to the service position.

2. The personal communication structure of claim 1, wherein the field replaceable unit comprises at least one of a Wi-Fi component, a small cell component, and an antenna component.

3. The personal communication structure of claim 1, wherein the installed position is proximate a top of the frame.

4. The personal communication structure of claim 1, wherein the at least one bearing is disposed in a bracket attached to the field replaceable unit.

5. The personal communication structure of claim 1, wherein the mechanism further comprises:
a tray supporting at least one component of the field replaceable unit;
a first pair of brackets attached to the tray; and
a second pair of brackets attached to the frame and engaged with the first pair of brackets, wherein the first pair of brackets are configured to slide along the second pair of brackets, using the at least one bearing.

6. A method of servicing a personal communication structure, the method comprising:
sliding a field replaceable unit from an installed position on a frame of the personal communication structure to a second position outside the frame, wherein the sliding is achieved using at least one bracket attached to the field replaceable unit and slidably engaged with at least one bracket attached to the frame;
tilting the field replaceable unit relative to the personal communication structure from the second position to a service position using at least one hinge;
removing at least one component from the field replaceable unit;
installing a corresponding at least one component into the field replaceable unit;
tilting the field replaceable unit from the service position to the second position; and
sliding the field replaceable unit from the second position to the installed position.

7. The method of claim 6, wherein the at least one component comprises at least one of a Wi-Fi component, a small cell component, and an antenna component.

8. The method of claim 6, wherein the installed position is proximate a top of the frame.

9. The method of claim 6, wherein at least one of (i) the at least one bracket attached to the field replaceable unit and (ii) the at least one bracket attached to the frame comprise a bearing.

10. The method of claim 6, wherein the corresponding at least one component comprises a replacement for the at least one component.

11-20. (canceled)

21. The personal communication structure of claim 1, wherein the field replaceable unit comprises
a frame; and
at least one of an RF bay field replaceable unit, a display field replaceable unit, a user interface field replaceable unit, an environmental sensor field replaceable unit, an electronics bay field replaceable unit, and a network bay field replaceable unit.

22. The personal communication structure of claim 1, wherein the field replaceable unit is disposed in a compartment defined by the frame.

23. The personal communication structure of claim 1, wherein the personal communication structure is configured to be field serviceable down to the frame.

24. The personal communication structure of claim 1, wherein the field replaceable unit is configured to be serviced by a person standing on ground supporting the frame when the field replaceable unit is in the service position.

25-28. (canceled)

29. The method of claim 6, further comprising:
running a self-test to detect a fault associated with the field replaceable unit;
transmitting information about the fault from the personal communication structure to a remote entity;
deploying field service personnel with the corresponding at least one component to a location where the personal communication structure is installed;
permitting the field service personnel to gain access to the field replaceable unit; and
running a self-test to confirm good working order of the corresponding at least one component.

30. The method of claim 29, wherein permitting the field service personnel to gain access comprises sending a request and receiving a grant to unlock a compartment containing the field replaceable unit.

31. (canceled)

32. (canceled)

33. The personal communication structure of claim 1, further comprising a quick release mechanism configured to disengage the field replaceable unit when the field replaceable unit is in the service position.

34. The personal communication structure of claim 1, wherein the field replaceable unit is configured to be hand carried.

35. The personal communication structure of claim 1, wherein the field replaceable unit is configured to be moved to at least one of the installed position and the service position by use of a cane tool.

36. The personal communication structure of claim 22, further comprising a device for opening and closing a cover for the compartment, the device comprising at least one of a spring, an actuator, an air cylinder, and a solenoid.

37. The personal communication structure of claim 36, wherein the cover is configured to open when a button on a user interface is pressed.
